(19) United States
(12) Patent Application Publication
(10) Pub. No.: US 2026/0242613 A1
(43) Pub. Date: Aug. 20, 2026

(54) ACRYLIC COPOLYMERS IMPARTING LOW YELLOWING AFTER PHOTOCURING

(71) Applicant: Arkema France, Colombes (FR)

(72) Inventors: Christopher MACNEILL, Exton, PA (US); Jon SCHOLTE, Exton, PA (US); Renee KONTOS, King of Prussia, PA (US); Linda FRANCESCHINI, Exton (PA); Philippe CICERON, Senlis (FR); Kevin DEMOULIN, Verneuil En Halatte (FR); Pierre MELEC, Verneuil En Halatte (FR); Christophe VERGE, Verneuil En Halatte (FR)

(21) Appl. No.: 18/995,276

(22) PCT Filed: Jul. 20, 2023
(86) PCT No.: PCT/EP2023/070236

§ 371 Date: Jan. 16, 2025

(30) Foreign Application Priority Data
Jul. 20, 2022 (EP) 22.306080.7

(51) Int. Cl. C09D 4/06; C08F 220/18; C09B 69/10; C09D 7/41; C09D 133/14

(52) U.S. Cl. CPC C09D 4/06; C08F 220/1804; C09B 69/109; C09D 7/41; C09D 133/14; C08F 2800/20; C08F 2810/20

(57) ABSTRACT

An acrylic copolymer comprising polymerized high-Tg monomer units and/or polymerized low-Tg monomer units; polymerized chromophore monomer units comprising a chromophore moiety selected from a thioxanthone, an anthraquinone, or a camphorquinone; and optionally polymerized additional monomer units is provided. A cured composition is also provided that is a product of photocuring a composition comprising the acrylic copolymer wherein the cured composition exhibits low yellowing. Also provided is a method of coating a substrate comprising applying a composition including the acrylic copolymer to the substrate and exposing the coating to UV radiation to cure the composition.

### TECHNICAL FIELD

Embodiments of the present disclosure generally relate to acrylic copolymers and, more specifically, to acrylic copolymers comprising pendant photoinitiators that impart low yellowing after photocuring.

### BACKGROUND

Radiation curable compositions are used in a host of different applications, from industrial coatings and graphic arts to UV curable nail gel and 3D printing. Small molecule photoinitiators are a crucial component in such compositions because they can promote polymerization upon exposure to a suitable light source.

The selection of small molecule photoinitiator(s) in a radiation curable composition influences the light source required to initiate polymerization as well as the properties of the photocured polymer. For example, small molecule photoinitiators that promote polymerization upon exposure to light at short wavelengths tend to be non-yellowing and provide good surface cure with poor depth of cure. In contrast, small molecule photoinitiators that promote polymerization upon exposure to light at long wavelengths tend to give high yellowing and good depth of cure, but poor surface cure, which can result in a tacky surface.

Small molecule photoinitiators can further be categorized as Norrish Type I or Norrish Type II. Norrish Type I photoinitiators cleave upon exposure to a suitable light source to form two radical species that induce crosslinking. Norrish Type II photoinitiators generate an excited state upon exposure to a suitable light source and cause hydrogen extraction from a co-initiator, which generates a radical to induce crosslinking.

Commonly used Norrish Type II photoinitiators include benzophenones, thioxanthones, camphorquinones, and anthraquinones. These photoinitiators are typically paired with co-initiators such as amines, alcohols, and ethers. Tertiary amines are most commonly used as co-initiators because of their high reactivity towards Norrish Type II photoinitiators in their excited state.

Norrish Type II photoinitiators having absorption bands at longer wavelengths (i.e., thioxanthones) may be particularly effective photoinitiators for certain applications. In particular, additives in some radiation curable compositions can absorb light at shorter wavelengths and thereby inhibit photoinitiators that absorb light at similar wavelengths from properly initiating polymerization, which can lead to improper curing. Because the additives may not absorb light at longer wavelengths, their inhibiting effect may be reduced when Norrish Type II photoinitiators having absorption bands at longer wavelengths (i.e., thioxanthones) are used.

### SUMMARY

Despite the utility of thioxanthones and other Norrish Type II photoinitiators having absorption bands at longer wavelengths, they are not without shortcomings. In particular, they tend to impart yellowing to the cross-linked polymer and do not photobleach over time. Further, they may be difficult to remove from the cross-linked polymer and instead may remain within the polymer matrix and diffuse slowly to the surface over time. Such photoinitiator migration may be harmful depending on the application. Accordingly, there is a need for Norrish Type II photoinitiators having absorption bands at longer wavelengths that provide cross-linked polymers with low initial yellowing and exhibit little to no migration after curing.

Embodiments of the acrylic copolymers disclosed herein meet this need through the incorporation of pendant Norrish Type II photoinitiators having absorption bands at longer wavelengths attached to the oligomer backbone. When the acrylic copolymers are mixed with at least one (meth)acrylate monomer, and the resulting composition is photocured, the resulting polymer may exhibit low yellowing. Further, since the acrylic copolymer becomes incorporated into the polymer framework upon photocuring, the photoinitiator moiety may exhibit little to no migration.

In one or more embodiments, an acrylic copolymer is provided. The acrylic copolymer comprises the reaction product of (1) a high-T_{g} monomer having a glass transition temperature (T_{g}) equal to or greater than 25° C., a low-T_{g} monomer having a T_{g} less than 25° C., or a combination of a high-T_{g} monomer having a glass transition temperature (T_{g}) equal to or greater than 25° C. and a low-T_{g} monomer having a T_{g} less than 25° C., (2) a chromophore monomer comprising a moiety chosen from a thioxanthone, an anthraquinone, or a camphorquinone, and (3) an optional at least one additional monomer.

In some embodiments, a curable composition is provided. The curable composition comprises the acrylic copolymer of the invention and a reactive diluent.

In some embodiments, a method of preparing a curable composition is provided. The method comprises the following steps:
preparing an acrylic copolymer according to the invention dissolved in a non-reactive solvent;
adding a reactive diluent to obtain a diluted curable composition;
removing at least part of the non-reactive solvent from the diluted curable composition to obtain a curable composition.

In some embodiments, a method of curing a curable composition is provided. The method comprises curing a curable composition by irradiating the curable composition with a light source having a wavelength and/or an intensity that is able to activate the polymerized chromophore monomer units of the acrylic copolymer and cause crosslinking of said acrylic copolymer and/or said reactive diluent.

In some embodiments, a cured composition is provided. The cured composition is a product of photocuring a composition including the acrylic copolymer and a reactive diluent, preferably at least one (meth)acrylate monomer. The cured composition exhibits an APHA-10 mm initial color from 0.1 to 50; an initial yellowness (b*) from 0.01 to 2; and a T_{g} of equal to or greater than 0° C.

In one or more embodiments, a method of coating a substrate is provided. The method includes applying a composition to a substrate to form an uncured coating of the composition on the substrate. The composition includes the acrylic copolymer and a reactive diluent, preferably at least one (meth)acrylate monomer. The method further includes exposing the uncured coating to UV radiation to cure the composition and obtain a cured coating on the substrate.

Additional features and advantages of the described embodiments will be set forth in the detailed description which follows, and in part will be readily apparent to those skilled in the art from that description or recognized by practicing the described embodiments, including the detailed description which follows, the claims, as well as the appended drawings.

### DETAILED DESCRIPTION

### Definitions

As used herein, the term “comprises a” can mean “comprises one or more”.

Unless otherwise mentioned, the weight percentages in a compound or a composition are expressed relative to the weight of the compound, respectively of the composition.

The term “substitution” herein means that at least one hydrogen atom (—H) bonded to a carbon atom or heteroatom of a corresponding unsubstituted compound or functional group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent. Unless otherwise defined or limited in a specific context, a substituent group generally, or a substituent group referred to as R^{S}, may be any chemical moiety, typically, but not necessarily limited to, a chemical moiety having from 1 to 50, or from 1 to 40, or from 1 to 30, or from 1 to 20, or from 1 to 10 total atoms. Examples of substituent groups R^{S} include, but are not limited to, a hydrocarbyl, a heterohydrocarbyl, an aryl, a heteroaryl, an alkyl, a cycloalkyl, a heteroatom, a carbonyl, a hydroxy, an ester, an amine, an amide, or a halide according to their respective definitions herein or their commonly understood meaning, any of which substituents themselves may be substituted or unsubstituted. In some embodiments, substituents R^{S} may be chosen from a (C₁-C₃₀) hydrocarbyl, a (C₁-C₃₀) heterohydrocarbyl, a (C₆-C₃₀) aryl, or a (C₆-C₃₀) heteroaryl.

The term “hydrocarbyl” means a monovalent hydrocarbon, in which each hydrocarbon is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S}, or unsubstituted. In this disclosure, hydrocarbyl may be an unsubstituted or substituted alkyl, an unsubstituted or substituted cycloalkyl, or an unsubstituted or substituted aryl. A hydrocarbyl may not comprise any heteroatom selected from O, N or S. A (C₁-C₃₀) hydrocarbyl is a hydrocarbyl having from 1 to 30 carbon atoms.

The term “heterohydrocarbyl” means a hydrocarbyl bearing one or more heteroatoms independently selected from O, N or S. A (C₁-C₃₀) heterohydrocarbyl is a heterohydrocarbyl having from 1 to 30 carbon atoms.

The term “aryl” means an optionally substituted polyunsaturated aromatic group. The aryl may contain a single ring (i.e. phenyl) or more than one ring wherein at least one ring is aromatic. When the aryl comprises more than one more ring, the rings may be fused, linked via a covalent bond (for example biphenyl). The aromatic ring may optionally comprise one to two additional fused rings (i.e. cycloalkyl, heterocycloalkyl or heteroaryl). Examples include phenyl, naphthyl, biphenyl, phenanthrenyl and naphthacenyl.

The term “alkyl” means a monovalent saturated acyclic hydrocarbon group of formula —CₙH₂ₙ₊₁ wherein n is 1 to 20. An alkyl may be linear or branched. Examples of alkyl groups include methyl, ethyl, propyl, isopropyl, butyl, isobutyl, tert-butyl, pentyl, hexyl, 2-methylbutyl, 2,2-dimethylpropyl, n-hexyl, 2-methylpentyl, 2,2-dimethylbutyl, n-heptyl, 2-ethylhexyl, and the like.

The term “cycloalkyl” means a monovalent saturated alicyclic hydrocarbon group comprising a cycle. Examples of cycloalkyl groups include cyclopentyl, cyclohexyl, and isobornyl, any of which may be substituted or unsubstituted.

The term “heterocycloalkyl” means a cycloalkyl having at least one ring atom that is a heteroatom selected from O, N, or S.

The term “halogen” means an atom selected from C₁, Br, F and I.

The term “alkoxy” means a group of formula-O-alkyl, wherein the alkyl is as defined above.

The term “aryloxy” means a group of formula-O-aryl, wherein the aryl is as defined above.

The term “thioalkyl” means a group of formula-S-alkyl, wherein the alkyl is as defined above.

The term “thioaryl” means a group of formula-S-aryl, wherein the aryl is as defined above.

The term “alkenyl” means a monovalent acyclic hydrocarbon group comprising at least one C═C double bond. An alkenyl may be linear or branched.

The term “alkynyl” means a monovalent acyclic hydrocarbon group comprising at least one C≡C triple bond. An alkynyl may be linear or branched.

The term “aralkyl” means an aryl substituted by an alkyl group. An example of an aralkyl group is tolyl.

The term “alkaryl” means an alkyl substituted by an aryl group. An example of an alkaryl group is benzyl (—CH₂-Phenyl).

The term “heteroaryl” means an aryl having at least one ring atom that is a heteroatom.

The term “alkylamino” means an alkyl substituted by at least one amino group.

The term “alkylthiol” means an alkyl substituted by at least one thiol group

The term “hydroxyalkyl” means an alkyl substituted by at least one hydroxy group.

The term “haloalkyl” means an alkyl substituted by at least one halogen.

The term “alkylene” or “alkanediyl” means a linker derived from an alkane of formula CₘH₂ₘ₊₂ by removing one hydrogen atom at each point of attachment of the linker. An alkylene may be divalent, trivalent, tetravalent or have even higher valencies.

The term “alkoxylated” means a compound, group or linker containing one or more oxyalkylene moieties, in particular one or more oxyalkylene selected from oxyethylene (—O—CH₂—CH₂—), oxypropylene (—O—CH₂—CH(CH₃) or —O—CH(CH₃)—CH₂—), oxybutylene (—O—CH₂—CH₂—CH₂—CH₂—) and mixtures thereof. For example, an alkoxylated compound, group or linker may contain from 1 to 30 oxyalkylene moieties.

The term “(meth)acrylate” means acrylate or methacrylate. The term “acrylate” means an acryloyloxy group (—O—C(═O)—CH—CH₂). The term “methacrylate” means a methacryloyloxy group (—O—C(═O)—C(CH₃)═CH₂).

The term (meth)acrylate monomer means a monomer bearing a (meth)acrylate group.

As used herein, the “monomers” have a number average molecular weight of less than 1,000 g/mol, preferably 100 to 950 g/mol.

As used herein, the “oligomers” have a number average molecular weight from equal to or more than 1,000 g/mol, preferably 1,050 to 60,000 g/mol, more preferably 10,000 to 50,000 g/mol.

The term “glass transition temperature” or “T_{g}” refers to the temperature at which a material changes from a glassy state to a rubbery state. In this context, the term “glassy” means that the material is hard and brittle while the term “rubbery” means that the material is elastic and flexible. For polymeric materials, the T_{g} is the critical temperature that separates their glassy and rubbery behaviors. If a polymeric material is at a temperature below its T_{g}, large-scale molecular motion is severely restricted because the material is essentially frozen. On the other hand, if the polymeric material is at a temperature above its T_{g}, molecular motion on the scale of its repeat unit takes place, allowing it to be soft or rubbery.

All references herein to a T_{g} of a monomer refer to the T_{g} of a homopolymer formed from that monomer. T_{g} values of common monomers are well-known from literature. If not reported in the literature, glass transition temperature values may be determined in accordance with ASTM E1356-08, “Standard Test Method for Assignment of the Glass Transition Temperatures by Differential Scanning calorimetry” as the inflection temperature (Ti). The glass transition temperatures of the acrylic copolymers described herein and mentioned in the examples below are calculated using the Fox Equation based on the mass fractions and T_{g} values of each individual monomer of the oligomer or polymeric material that includes more than one discrete type of monomer.

The terms “mass fraction” and “weight fraction” are used herein interchangeably and are to be regarded as equivalent to each other with respect to embodiments or examples herein.

The “Fox Equation” refers to equation (1):

$$1 / {T}_{g , mix} = \sum i {ω}_{i} / {T}_{g , i} \qquad equation ( 1 )$$

where T_{g, mix} is the glass transition temperature of a mixture of i chemically discrete components, such as two or more discrete monomers of an oligomer or polymer, T_{g,i} is the glass transition temperature of the i-th component, and ωᵢ is the mass fraction of the i-th component, based on the total mass of the oligomer or polymer. Hereinafter, the value T_{g, mix} with respect to multiple discrete monomers in an oligomer or polymer is referred to as the “Fox Equation average T_{g}” of the multiple discrete monomers.

For two components, A and B, the Fox Equation reduces to equation (2):

$$1 / {T}_{g , mix} = {ω}_{A} / {T}_{g , A} + {ω}_{B} / {T}_{g , B} \qquad equation ( 2 )$$

The term “high-T_{g} monomer unit” refers to a monomer that, when homopolymerized, produces a homopolymer having a T_{g} of equal to or greater than 25° C. In embodiments of the oligomer, for which only one kind of high-T_{g} monomer unit is present in the oligomer, the T_{g} of the high-T_{g} monomer units is the T_{g} of a homopolymer of the one kind of high-T_{g} monomer unit. In embodiments of the oligomer, for which two or more types of distinct high-T_{g} monomer units are present in the oligomer, the T_{g} of the high-T_{g} monomer units of the oligomer collectively refers to the Fox Equation average T_{g} of the combination of the high-T_{g} monomer units, in which for equation (1) the individual mass fractions ωᵢ are mass fractions of each individual high-T_{g} monomer unit in the oligomer, based on the total mass of all the high-T_{g} monomer units present in the oligomer (that is, the monomer units having a T_{g} of equal to or greater than 25° C.), not on the total mass of the oligomer as a whole.

The term “Fox Equation average” may be used herein even with respect to a single monomer that is not part of a mixture of two or more monomers. It should be readily understood that a Fox Equation average T_{g} with respect to a single monomer is equivalent to the T_{g} of the single monomer itself, as defined herein, as the term mass fraction term @ in such a situation would equal one.

The term “low-T_{g} monomer unit” refers to a monomer that, when homopolymerized, produces a homopolymer having a T_{g} of less than 25° C. In embodiments of the oligomer, for which only one kind of low-T_{g} monomer unit is present in the oligomer, the T_{g} of the low-T_{g} monomer units is the T_{g} of a homopolymer of the one kind of low-T_{g} monomer unit. In embodiments of the oligomer, for which two or more types of distinct low-T_{g} monomer units are present in the oligomer, the T_{g} of the low-T_{g} monomer units of the oligomer collectively refers to the Fox Equation average T_{g} of the combination of the low-T_{g} monomer units, in which for equation (1) the individual mass fractions di are mass fractions of each individual low-T_{g} monomer unit in the oligomer, based on the total mass of all the low-T_{g} monomer units present in the oligomer (that is, the monomer units having a T_{g} of less than 25° C.), not on the total mass of the oligomer as a whole.

The term “photoinitiator”, may be considered any type of substance that, upon exposure to radiation (e.g., actinic radiation), forms species that initiate the reaction and curing of polymerizing organic substances present in a curable composition.

The term “chromophore” refers herein to a Norrish Type II light absorbing molecule that enters an excited state upon absorbing light. From this excited state, the molecule can interact or react with other molecules to produce reactive radical species.

The term “independently selected” is used herein to indicate that the substituent groups, such as, Z¹, Z², Z³, and Z⁴, can be identical or different (e.g., Z¹, Z², Z³, and Z⁴ may all be —CH₃ or Z¹ and Z² may be —CH₃ and Z³ and Z⁴ may be —H, etc.) A chemical name associated with a substituent group is intended to convey the chemical structure that is recognized in the art as corresponding to that of the chemical name. Thus, chemical names are intended to supplement and illustrate, not preclude, the structural definitions known to those of skill in the art.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₂₀) hydrocarbyl is a hydrocarbyl group having from 1 to 20 carbon atoms in its unsubstituted form. In some embodiments and general structures, certain chemical groups may be substituted by one or more substituents such as R^{S}. An R^{S} substituted version of a chemical group defined using the “(Cₓ-C_{y})” parenthetical may contain more than y carbon atoms depending on the identity of any groups R^{S}. For example, a “(C₁-C₂₀)alkyl substituted with exactly one group R^{S}, where R^{S} is phenyl (—C₆H₅)” may contain from 7 to 27 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “—H” means a hydrogen atom that is covalently bonded to an atom other than hydrogen. “Hydrogen” and “—H” are interchangeable, and, unless clearly specified, have identical meanings.

The term “(C₁-C₃₀) hydrocarbyl” means a monovalent hydrocarbon of from 1 to 30 carbon atoms, in which each monovalent hydrocarbon is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S}, or unsubstituted. In this disclosure, a (C₁-C₃₀) hydrocarbyl may be an unsubstituted or substituted (C₁-C₃₀)alkyl, (C₃-C₃₀) cycloalkyl, or (C₆-C₃₀) aryl.

The term “(C₂-C₃₀)alkyl” mean a saturated straight or branched monovalent hydrocarbon of from 2 to 30 carbon atoms that is unsubstituted or substituted by one or more R^{S}. Examples of unsubstituted (C₂-C₃₀)alkyl are unsubstituted (C₂-C₂₀)alkyl; unsubstituted (C₆-C₂₅)alkyl; unsubstituted (C₄-C₅)alkyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₂-C₃₀)alkyl are substituted (C₂-C₂₀)alkyl, substituted (C₂-C₁₀)alkyl.

The term “(C₆-C₄₀) aryl” means an unsubstituted or substituted (by one or more R^{S}) monocyclic, bicyclic, or tricyclic aromatic monovalent hydrocarbon of from 6 to 40 carbon atoms, of which at least from 6 to 14 of the carbon atoms are aromatic ring carbon atoms. A monocyclic aromatic monovalent hydrocarbon includes one aromatic ring; a bicyclic aromatic monovalent hydrocarbon has two rings; and a tricyclic aromatic monovalent hydrocarbon has three rings. When the bicyclic or tricyclic aromatic monovalent hydrocarbon is present, at least one of the rings of the monovalent hydrocarbon is aromatic. The other ring or rings of the aromatic monovalent hydrocarbon may be independently fused or non-fused and aromatic or non-aromatic. Examples of unsubstituted (C₆-C₄₀) aryl include: unsubstituted (C₆-C₂₀) aryl, unsubstituted (C₆-C₁₈) aryl; 2-(C₁-C₅)alkyl-phenyl; phenyl; fluorenyl; tetrahydrofluorenyl; idacenyl; hexahydracenyl; hexahydroindacenyl; indenyl; dihydroindenyl; naphthyl; tetrahydronaphthyl; and phenanthrene. Examples of substituted (C₆-C₄₀) aryl include: substituted (C₁-C₂₀) aryl; and substituted (C₆-C₁₈) aryl.

The term “(C₆-C₁₂) cycloalkyl” means a saturated cyclic monovalent hydrocarbon of from 6 to 12 carbon atoms that is unsubstituted or substituted. Other cycloalkyl groups (e.g., (Cₓ-C_{y})cycloalkyl) are defined in an analogous manner as having from x to y carbon atoms and being either unsubstituted or substituted by one or more R^{S}. Examples of unsubstituted (C₆-C₁₂) cycloalkyl are unsubstituted (C₆-C₅) cycloalkyl, unsubstituted (C₆-C₁₀) cycloalkyl, cyclopropyl, cyclobutyl, cyclopentyl, cyclohexyl, cycioheptyl, cyclooctyl, cyclononyl, and cyclodecyl. Examples of substituted (C₆-C₁₂) cycloalkyl are substituted (C₆-C₅) cycloalkyl, substituted (C₆-C₁₀) cycloalkyl, isobornyl, and 3,3,5-trimethylcyclohexyl.

The term “heteroatom,” refers to an atom other than hydrogen or carbon. Examples of heteroatoms include O, S, N, Si. The term “heterohydrocarbon” refers to a molecule or molecular framework in which one or more carbon atoms of a hydrocarbon are replaced with a heteroatom. The term “(C₁-C₃₀) heterohydrocarbyl” means a monovalent heterohydrocarbon of from 1 to 30 to carbon atoms, and the term “(C₁-C₃₀) heterohydrocarbylene” means a divalent heterohydrocarbon of from 1 to 30 carbon atoms. The heterohydrocarbon of the (C₁-C₃₀) heterohydrocarbyl or the (C₁-C₃₀) heterohydrocarbylene has one or more heteroatoms. The valency or connection point of the heterohydrocarbyl may be on a carbon atom or a heteroatom. The two valencies of the heterohydrocarbylene may be on a single carbon atom or on a single heteroatom. Additionally, one of the two valencies or connection points of the diradical may be on a carbon atom and the other valency may be on a different carbon atom; one of the two valencies or connection points may be on a carbon atom and the other on a heteroatom; or one of the two valencies or connection points may be on a heteroatom and the other valency or connection point on a different heteroatom. Each (C₁-C₃₀) heterohydrocarbyl and (C₁-C₃₀) heterohydrocarbylene may be unsubstituted or substituted, aromatic or non-aromatic, saturated or unsaturated, straight chain or branched chain, cyclic (including mono- and poly-cyclic, fused and non-fused polycyclic), or acyclic.

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double and/or triple bonds optionally may or may not be present in substituents R^{S}. The term “unsaturated” means containing one or more carbon-carbon double bonds, carbon-carbon triple bonds, or (in heteroatom-containing groups) one or more carbon-nitrogen, carbon-phosphorous, or carbon-silicon double bonds, not including double bonds that may be present in substituents R^{S}, if any, or in (hetero) aromatic rings, if any.

The term “linker” means a multivalent group. A linker may connect at least two moieties of a compound together, in particular 2 to 16 moieties of a compound together. For example, a linker that connects two moieties of a compound together is referred to as a divalent linker and a linker that connects three moieties of a compound together is referred to as a trivalent linker.

As used herein, “weight average molecular weight (‘M_{w}’)” is determined by size exclusion chromatography (SEC) using polymethyl methacrylate reference standards and tetrahydrofuran as the solvent, unless expressly noted otherwise.

It was discovered that embodiments of acrylic copolymers described herein that include a pendant Norrish Type II photoinitiator having absorption bands at longer wavelengths (i.e., a thioxanthone, an anthraquinone, or a camphorquinone) that are mixed with at least one (meth)acrylate monomer, and the resulting composition is photocured, the resulting polymer may exhibit low yellowing. Without being bound by theory, it is believed that a reason for the relatively high yellowing exhibited by compositions cured with small molecule Norrish Type II photoinitiators having absorption bands at longer wavelengths is that the small molecule photoinitiators react to form dimers and other side products during curing, which impart yellowing to the cured composition. It is believed that the opportunity for photoinitiator dimerization is substantially reduced when the photoinitiators are covalently attached to acrylic copolymers such as embodiments of the acrylic copolymers described herein. Further, since embodiments of the acrylic copolymer described herein becomes incorporated into the polymer framework upon photocuring, the photoinitiator moiety may exhibit little to no migration.

### Acrylic Copolymer

The acrylic copolymers (also referred to as the oligomers) herein include at least one polymerized chromophore monomer unit, as defined herein. The acrylic copolymers herein further include at least one polymerized monomer unit selected from a polymerized high-T_{g} monomer unit, a polymerized low-T_{g} monomer unit, or a combination of at least one polymerized high-T_{g} monomer unit and at least one polymerized low-T_{g} monomer unit. The acrylic copolymers herein optionally include at least one polymerized additional monomer unit, as defined herein. The acrylic copolymer may not comprise polymerized monomer units other than the polymerized high-Tg monomer units, the polymerized low Tg monomer unit, the polymerized chromophore monomer units, and the optional polymerized additional monomer units. The total weight of the polymerized high-Tg monomer units, the polymerized low Tg monomer unit, the polymerized chromophore monomer units, and the polymerized additional monomer units may represent at least 97%, in particular at least 98%, more particularly at least 99%, more particularly still 100% of the total weight of the acrylic copolymer.

In embodiments, the acrylic copolymer comprises from 0% to 99.9% by weight polymerized high-T_{g} monomer units, from 0% to 99.9% by weight polymerized low-T_{g} monomer units, from 0.1% to 40% by weight polymerized chromophore monomer units, and from 0 to 20% by weight polymerized additional monomer units, based on the total weight of the acrylic copolymer, provided the acrylic copolymer includes at least 40% by weight, or at least 50% by weight, or at least 60% by weight, or at least 70% by weight, or at least 80% by weight, or at least 90% by weight combined total of polymerized high-T_{g} monomer units and polymerized low-T_{g} monomer units.

In one or more embodiments, an acrylic copolymer comprises the reaction product of a high-T_{g} monomer having a glass transition temperature (T_{g}) equal to or greater than 25° C., a chromophore monomer comprising a moiety chosen from a thioxanthone, an anthraquinone, or a camphorquinone, and an optional at least one additional monomer. According to one or more embodiments, the chromophore monomer comprises a moiety comprising a thioxanthone.

In one or more embodiments, an acrylic copolymer comprises the reaction product of a low-T_{g} monomer having a T_{g} less than 25° C., a chromophore monomer comprising a moiety chosen from a thioxanthone, an anthraquinone, or a camphorquinone, and an optional at least one additional monomer. According to one or more embodiments, the chromophore monomer comprises a moiety comprising a thioxanthone.

In one or more embodiments, an acrylic copolymer comprises the reaction product of a high-T_{g} monomer having a glass transition temperature (T_{g}) equal to or greater than 25° C., a low-T_{g} monomer having a T_{g} less than 25° C., a chromophore monomer comprising a moiety chosen from a thioxanthone, an anthraquinone, or a camphorquinone, and an optional at least one additional monomer. According to one or more embodiments, the chromophore monomer comprises a moiety comprising a thioxanthone.

In embodiments, the acrylic copolymer has formula (I):

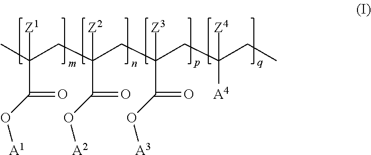

wherein:
each A¹ is independently (C₁-C₃₀) hydrocarbyl or (C₁-C₃₀) heterohydrocarbyl, preferably (C₁-C₃₀) hydrocarbyl;
each A² is independently (C₄-C₃₀) hydrocarbyl or (C₄-C₃₀) heterohydrocarbyl, preferably (C₄-C₃₀) hydrocarbyl;
each A³ is independently a residue comprising a monovalent radical comprising a moiety chosen from a thioxanthone, an anthraquinone, or a camphorquinone, preferably a thioxanthone;
each A⁴ is independently a (C₁-C₃₀) hydrocarbyl or (C₁-C₃₀) heterohydrocarbyl;
Z¹, Z², Z³, and Z⁴ are independently-H or (C₁-C₄)alkyl, preferably-H or —CH₃;
m is a weight fraction of the high-T_{g} monomer and is from 0 to 0.999;
n is a weight fraction of the low-T_{g} monomer and is from 0 to 0.999;
p is a weight fraction of the chromophore monomer and is from 0.001 to 0.4;
q is a weight fraction of the additional monomer and is from 0 to 0.2;
m+n is greater than or equal to 0.4; and
m+n+p+q=1.

In embodiments, m is from 0.001 to 0.999, preferably 0.01 to 0.50; n is from 0.001 to 0.999, preferably from 0.50 to 0.98; and m+n is greater than or equal to 0.6.

### High Tg Monomer Units

The acrylic copolymer disclosed herein may include polymerized high T_{g} monomer units. The high-T_{g} monomer units are distinct from the low-T_{g} monomer units, the chromophore monomer units and the additional monomer units. Accordingly, the high-T_{g} monomer units may not comprise any of the following groups:
a chromophore moiety
a functional group as defined below for the additional monomer units.

The polymerized high-T_{g} monomer units may be identical or a combination of multiple types of discrete monomer units such as two types of discrete monomer units, three types of discrete monomer units, four types of discrete monomer units, or more than four types of discrete monomer units. In embodiments, the high-T_{g} monomer units have a glass transition temperature (T_{g}) or a Fox Equation average T_{g} equal to or greater than 25° C. As defined herein, any reference herein to the T_{g} of a monomer refers to the T_{g} of a homopolymer formed from that monomer. In embodiments where the acrylic copolymer comprises two or more distinct high-T_{g} monomer units, such as a combination of methyl (meth)acrylate and isobornyl (meth)acrylate, the T_{g} refers to the Fox Equation average T_{g} of the high-T_{g} monomer units, as defined previously herein. In embodiments, the Fox Equation average T_{g} of the high-T_{g} monomer units is greater than 25° C., such as equal to or greater than 30° C., equal to or greater than 35° C., equal to or greater than 40° C., equal to or greater than 45° C., equal to or greater than 50° C., equal to or greater than 55° C., equal to or greater than 60° C., equal to or greater than 65° C., equal to or greater than 70° C., equal to or greater than 75° C., or even equal to or greater than 80° C. In embodiments, the high T_{g} monomer units may have a T_{g} from 25° C. to 200° C., from 25° C. to 150° C., from 25° C. to 130° C., from 30° C. to 200° C., from 30° C. to 150° C., from 30° C. to 130° C., from 35° C. to 200° C., from 35° C. to 150° C., from 35° C. to 130° C., from 40° C. to 200° C., from 40° C. to 150° C., from 40° C. to 130° C., from 45° C. to 200° C., from 45° C. to 150° C., from 45° C. to 130° C., from 50° C. to 200° C., from 50° C. to 150° C., from 50° C. to 130° C., from 55° C. to 200° C., from 55° C. to 150° C., from 55° C. to 130° C., from 60° C. to 200° C., from 60° C. to 150° C., from 60° C. to 130° C., from 65° C. to 200° C., from 65° C. to 150° C., from 65° C. to 130° C., from 70° C. to 200° C., from 70° C. to 150° C., from 70° C. to 130° C., from 75° C. to 200° C., from 75° C. to 150° C., or even from 75° C. to 130° C., or any and all subranges formed from any of these endpoints.

If the acrylic copolymer includes both high-T_{g} monomer and low-T_{g} monomers (i.e., both m and n of formula (I) are non-zero), the Fox Equation average T_{g} of the high-T_{g} monomer units is greater than the Fox Equation average T_{g} of the low-T_{g} monomer units. In embodiments the Fox Equation average T_{g} of the high-T_{g} monomer units is at least 20° C. greater than the Fox Equation average T_{g} of the low-T_{g} monomer units. In embodiments, the difference between the Fox Equation average T_{g} of the high-T_{g} monomer units and the Fox Equation average T_{g} of the low-T_{g} monomer units is greater than 20° C., such as greater than 25° C., greater than 30° C., greater than 35° C., greater than 40° C., greater than 45° C., greater than 50° C., greater than 55° C., greater than 60° C., greater than 65° C., greater than 70° C., greater than 75° C., greater than 80° C., greater than 85° C., greater than 90° C., greater than 95° C., greater than 100° C., greater than 105° C., greater than 110° C., greater than 115° C., or greater than 120° C. In embodiments, the difference between the Fox Equation average T_{g} of the high-T_{g} monomer units and the Fox Equation average T_{g} of the low-T_{g} monomer units is from 20° C. to 200° C. As non-limiting examples the difference between the Fox Equation average T_{g} of the high-T_{g} monomer units and the Fox Equation average T_{g} of the low-T_{g} monomer units may be from 20° C. to 200° C., from 20° C. to 150° C., from 20° C. to 120° C., from 20° C. to 100° C., from 20° C. to 90° C., from 20° C. to 80° C., from 20° C. to 70° C., from 20° C. to 60° C., from 20° C. to 50° C., from 20° C. to 40° C., from 20° C. to 30° C., from 30° C. to 200° C., from 30° C. to 150° C., from 30° C. to 120° C., from 30° C. to 100° C., from 30° C. to 90° C., from 30° C. to 80° C., from 30° C. to 70° C., from 30° C. to 60° C., from 30° C. to 50° C., from 30° C. to 40° C., from 40° C. to 200° C., from 40° C. to 150° C., from 40° C. to 120° C., from 40° C. to 100° C., from 40° C. to 90° C., from 40° C. to 80° C., from 40° C. to 70° C., from 40° C. to 60° C., from 40° C. to 50° C., from 50° C. to 200° C., from 50° C. to 150° C., from 50° C. to 120° C., from 50° C. to 100° C., from 50° C. to 90° C., from 50° C. to 80° C., from 50° C. to 70° C., from 50° C. to 60° C., from 60° C. to 200° C., from 60° C. to 150° C., from 60° C. to 120° C., from 60° C. to 100° C., from 60° C. to 90° C., from 60° C. to 80° C., from 60° C. to 70° C., from 70° C. to 200° C., from 70° C. to 150° C., from 70° C. to 120° C., from 70° C. to 100° C., from 70° C. to 90° C., from 70° C. to 80° C., from 80° C. to 200° C., from 80° C. to 150° C., from 80° C. to 120° C., from 80° C. to 100° C., or from 80° C. to 90° C., or any and all subranges formed from any of these endpoints.

The high T_{g} monomer units consist of one or more (meth)acrylate monomers, preferably one or more monofunctional (meth)acrylate monomers.

In embodiments, the high T_{g} monomer units are monovalent. In other embodiments, the high T_{g} monomer units may be multivalent, where the individual monomer unit comprises two or more active sites that participate in crosslinking upon curing. Examples of monovalent monomer units may include ethyl methacrylate and tert-butyl acrylate. Examples of multivalent monomer units may include divalent monomer units, such as dicyclopentadienyl acrylate.

In embodiments, each of the high T_{g} monomer units (prior to being polymerized into the backbone of the acrylic copolymer) may independently be according to formula (II):

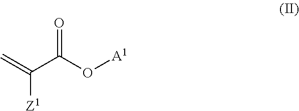

where:
   A¹ is (C₁-C₃₀) hydrocarbyl or (C₁-C₃₀) heterohydrocarbyl, preferably (C₁-C₃₀) hydrocarbyl; and
   Z¹ is —H or —CH₃.

For instance, in embodiments, A¹ may be chosen from methyl, ethyl, isopropyl, isobutyl, tert-butyl, a substituted or unsubstituted (C₆-C₁₂) cycloalkyl, a substituted or unsubstituted (C₆-C₁₂) aryl or combinations thereof. In embodiments, A¹ may be chosen from methyl, tert-butyl, isobornyl, cyclohexyl, or 3,3,5-trimethylcyclohexyl, phenyl, benzyl or combinations thereof.

Said embodiments equally apply to A¹ in the acrylic copolymer of formula (I).

In embodiments, the high-T_{g} monomer units can include (hydrocarbyl) acrylate ester monomers, including but not limited to (alkyl) acrylate ester monomers, (cycloalkyl) acrylate ester monomers, or (aryl) acrylate ester monomers. Examples of (alkyl) acrylate ester monomers include acrylate and (meth)acrylate ester monomers such as methyl (meth)acrylate. Examples of (cycloalkyl) acrylate ester monomers include acrylate ester monomers and IBOA, IBOMA. Examples of (aryl) acrylate ester monomers include acrylate ester monomers and phenyl (meth)acrylate and benzyl (meth)acrylate.

Examples of suitable high T_{g} monomer units may include, but not be limited to, monomers units chosen from 2-phenylethyl methacrylate, 3,3,5-trimethylcyclohexyl acrylate, tert-butyl acrylate, octadecyl methacrylate, octadecyl acrylate, propyl methacrylate, benzyl methacrylate, isobutyl methacrylate, ethyl methacrylate, 2,2,3,3-tetrafluoropropyl methacrylate, 2,2,2-trifluoroethyl methacrylate, isopropyl methacrylate, isobornyl acrylate, methyl methacrylate, isobornyl methacrylate, phenyl methacrylate, tert-butyl methacrylate, cyclohexyl methacrylate, 4-tert-butylcyclohexyl acrylate, 4-tert-butylcyclohexyl methacrylate, 3,3,5-trimethylcyclohexyl acrylate, 3,3,5-trimethylcyclohexyl methacrylate, a substituted or unsubstituted (C₆-C₁₂) cycloalkyl (meth)acrylate, adamantyl (meth)acrylate, tricyclodecane methanol mono(meth)acrylate, or combinations thereof.

Preferably, the high T_{g} monomer units of the acrylic copolymer are chosen from methyl methacrylate, tert-butyl (meth)acrylate, isobornyl (meth)acrylate, phenyl (meth)acrylate and benzyl (meth)acrylate or combinations thereof.

The weight fraction of the polymerized high-T_{g} monomers in the acrylic copolymer will vary depending on desired properties of the acrylic copolymer, such as T_{g}, molecular weight, and gel content after curing.

As described herein, m of formula (I) is a weight fraction of the polymerized high-T_{g} monomer. In some embodiments, m is from 0 to 0.999, provided the sum of m and n is at least 0.4. In further embodiments, m is greater than or equal to 0.01, such as greater than or equal to 0.05, greater than or equal to 0.1, greater than or equal to 0.15, greater than or equal to 0.2, greater than or equal to 0.25, greater than or equal to 0.30, greater than or equal to 0.35, greater than or equal to 0.40, greater than or equal to 0.45, greater than or equal to 0.50, greater than or equal to 0.55, or greater than or equal to 0.60. In embodiments, m is from 0.10 to 0.95, from 0.10 to 0.95, from 0.10 to 0.90, from 0.10 to 0.85, from 0.10 to 0.80, from 0.10 to 0.75, from 0.10 to 0.70, from 0.10 to 0.60, from 0.10 to 0.50, from 0.10 to 0.40, from 0.10 to 0.30, from 0.10 to 0.20, from 0.20 to 0.95, from 0.20 to 0.90, from 0.20 to 0.85, from 0.20 to 0.80, from 0.20 to 0.70, from 0.20 to 0.60, from 0.20 to 0.50, from 0.20 to 0.40, from 0.20 to 0.30, from 0.30 to 0.95, from 0.30 to 0.90, from 0.30 to 0.85, from 0.30 to 0.80, from 0.30 to 0.70, from 0.30 to 0.60, from 0.30 to 0.50, from 0.30 to 0.40, from 0.40 to 0.95, from 0.40 to 0.90, from 0.40 to 0.85, from 0.40 to 0.80, from 0.40 to 0.70, from 0.40 to 0.60, from 0.40 to 0.50, from 0.50 to 0.95, from 0.50 to 0.90, from 0.50 to 0.85, from 0.50 to 0.95, from 0.50 to 0.90, from 0.50 to 0.85, from 0.50 to 0.80, from 0.50 to 0.70, from 0.50 to 0.60, from 0.60 to 0.95, from 0.60 to 0.90, from 0.60 to 0.85, from 0.60 to 0.80, from 0.60 to 0.70, from 0.70 to 0.95, from 0.70 to 0.90, from 0.70 to 0.85, or from 0.70 to 0.80.

### Low T_{g} Monomer Units

The acrylic copolymers disclosed herein may include low T_{g} monomer units. The low T_{g} monomer units are distinct from the high-T_{g} monomer units, the chromophore monomer units and the additional monomer units. Accordingly, the low-T_{g} monomer units may not comprise any of the following groups:
a chromophore moiety
a functional group as defined below for the additional monomer units.

In embodiments, the acrylic copolymer includes polymerized low-T_{g} monomer units, optionally in combination with polymerized high-T_{g} monomer units. The polymerized low-T_{g} monomer units may be identical or a combination of multiple types of discrete monomer units such as two types of discrete monomer units, three types of discrete monomer units, four types of discrete monomer units, or more than four types of discrete monomer units. In embodiments, the low-T_{g} monomer units can have a glass transition temperature (T_{g}) less than 25° C. or a Fox Equation average T_{g} less than 25° C. As defined herein, any reference herein to the T_{g} of a monomer refers to the T_{g} of a homopolymer formed from that monomer. In embodiments where the acrylic copolymer comprises two or more distinct low-T_{g} monomer units, the T_{g} refers to the Fox Equation average T_{g} of the low-T_{g} monomer units, as defined previously herein. In embodiments, the low-T_{g} monomer units have a Fox Equation average T_{g} of less than 25° C., such as less than 20° C., less than 15° C., less than 10° C., less than 5° C., less than 0° C., less than −5° C., less than −10° C., less than −15° C., less than −20° C., or less than −30° C. In embodiments, the low-T_{g} monomer units have a Fox Equation average T_{g} of from −150° C. to 24° C., such as preferably −80° C. to 0° C., and most preferably from −60° C. to −10° C.

The low T_{g} monomer units consist of one or more (meth)acrylate monomers, preferably one or more monofunctional (meth)acrylate monomers.

In embodiments, the low T_{g} monomer units may be monovalent. In embodiments, the low T_{g} monomer units may include (meth)acrylate monomers, including acrylate monomers and methacrylate monomers. Examples of acrylate monomers include sec-butyl acrylate monomers and n-butyl acrylate monomers. Examples of methacrylate monomers include butyl methacrylate monomers and pentyl methacrylate monomers.

In embodiments, each of the low T_{g} monomer units (prior to being polymerized into the backbone of the acrylic copolymer) may independently be according to formula (II):

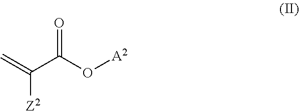

where:
   A² is (C₄-C₃₀) hydrocarbyl or (C₄-C₃₀) heterohydrocarbyl, preferably a (C₄-C₃₀) hydrocarbyl; and
   Z² is —H or —CH₃.

In embodiments, A² is a linear or branched (C₄-C₃₀)alkyl. In embodiments, A² is chosen from n-butyl, isobutyl, hexyl, 2-ethylhexyl, isooctyl, isodecyl, tridecyl, lauryl, or combinations thereof.

Said embodiments equally apply to A² in the acrylic copolymer of formula (I).

Further examples of low T_{g} monomer units of the acrylic copolymer include, but are not limited to, monomer units chosen from n-butyl (meth)acrylate, isobutyl acrylate, hexyl (meth)acrylate, 2-ethylhexyl (meth)acrylate, isooctyl (meth)acrylate, isodecyl (meth)acrylate, tridecyl (meth)acrylate, lauryl (meth)acrylate, nonyl acrylate, decyl (meth)acrylate, octyl (meth)acrylate, propyl acrylate, isobutyl acrylate, 2,2,3,3-tetrafluoropropyl acrylate, ethyl acrylate, sec-butyl acrylate, dodecyl acrylate, tetradecyl (meth)acrylate, isopropyl acrylate, pentyl (meth)acrylate, benzyl acrylate, cyclohexyl acrylate, hexadecyl (meth)acrylate, 2-methylbutyl acrylate, 2-octyl acrylate, or combinations thereof.

Preferably, the low T_{g} monomer units of the acrylic copolymer are n-butyl acrylate.

The weight fraction of the polymerized low-T_{g} monomers in the acrylic copolymer will vary depending on desired properties of the acrylic copolymer, such as T_{g}, molecular weight, and gel content after curing.

As described herein, n of formula (I) is a weight fraction of the polymerized low-T_{g} monomer. In some embodiments, n is from 0 to 0.999, provided the sum of m and n is at least 0.4. In embodiments, n is greater than or equal to 0.001, such as greater than or equal to 0.02, greater than or equal to 0.05, greater than or equal to 0.10, greater than or equal to 0.15, greater than or equal to 0.20, greater than or equal to 0.25, greater than or equal to 0.30, greater than or equal to 0.35, greater than or equal to 0.40, greater than or equal to 0.45, greater than or equal to 0.50, greater than or equal to 0.55, greater than or equal to 0.60, greater than or equal to 0.65, greater than or equal to 0.70, greater than or equal to 0.75, or greater than or equal to 0.80. In embodiments, n is from 0.001 to 0.989, from 0.001 to 0.90, from 0.001 to 0.80, from 0.001 to 0.70, from 0.001 to 0.60, from 0.001 to 0.50, from 0.001 to 0.40, from 0.001 to 0.30, from 0.001 to 0.20, from 0.001 to 0.10, from 0.001 to 0.05, from 0.01 to 0.989, from 0.01 to 0.90, from 0.01 to 0.80, from 0.01 to 0.70, from 0.01 to 0.60, from 0.01 to 0.50, from 0.01 to 0.40, from 0.01 to 0.30, from 0.01 to 0.20, from 0.01 to 0.10, from 0.01 to 0.05, from 0.05 to 0.989, from 0.05 to 0.90, from 0.05 to 0.80, from 0.05 to 0.70, from 0.05 to 0.60, from 0.05 to 0.50, from 0.05 to 0.40, from 0.05 to 0.30, from 0.05 to 0.20, from 0.05 to 0.10, from 0.10 to 0.989, from 0.10 to 0.90, from 0.10 to 0.80, from 0.10 to 0.70, from 0.10 to 0.60, from 0.10 to 0.50, from 0.10 to 0.40, from 0.10 to 0.30, from 0.10 to 0.20, from 0.20 to 0.989, from 0.20 to 0.90, from 0.20 to 0.80, from 0.20 to 0.70, from 0.20 to 0.60, from 0.20 to 0.50, from 0.20 to 0.40, from 0.20 to 0.30, from 0.30 to 0.989, from 0.30 to 0.90, from 0.30 to 0.80, from 0.30 to 0.70, from 0.30 to 0.60, from 0.30 to 0.50, from 0.30 to 0.40, from 0.40 to 0.989, from 0.40 to 0.90, from 0.40 to 0.80, from 0.40 to 0.70, from 0.40 to 0.60, from 0.40 to 0.50, from 0.50 to 0.989, from 0.50 to 0.90, from 0.50 to 0.80, from 0.50 to 0.70, from 0.50 to 0.60, from 0.60 to 0.989, from 0.60 to 0.90, from 0.60 to 0.80, from 0.60 to 0.70, from 0.70 to 0.989, from 0.70 to 0.90, from 0.70 to 0.80, from 0.80 to 0.989, from 0.80 to 0.90, or from 0.90 to 0.989.

When the acrylic copolymer includes both low T_{g} monomers and high T_{g} monomers, the weight ratio of low T_{g} monomers to high T_{g} monomers may be adjusted depending on desired properties of the acrylic copolymer, such as T_{g} and gel content after curing. In embodiments, the weight ratio of low T_{g} monomers to high T_{g} monomer units in the acrylic copolymer may be from 10:1 to 1:9, from 5:1 to 1:9, from 2:1 to 1:9, from 1:1 to 1:9, from 10:1 to 1:5, from 5:1 to 1:5, from 2:1 to 1:5, from 1:1 to 1:5, from 10:1 to 1:5, or any and all subranges formed from any of these endpoints.

### Chromophore Monomer Units

In addition to at least one polymerized high-T_{g} monomer unit, or at least one polymerized low-T_{g} monomer unit, or preferably a combination of at least one polymerized high-T_{g} monomer unit and at least one polymerized low-T_{g} monomer unit, the acrylic copolymers further include at least one polymerized chromophore monomer unit. The chromophore monomer units are distinct from the high T_{g} monomer units, the low T_{g} monomer units and the additional monomer units.

The polymerized chromophore monomer units may act as a photoinitiator and induce curing of the acrylic copolymer upon radiation. A photoinitiator is generally a moiety that, on absorption of light, generates reactive species (ions or radicals) and initiates one or several chemical reactions or transformations.

The polymerized chromophore monomer units comprise a free-radical photoinitiator moiety. The photoinitiator moiety may be selected so that it is susceptible to activation by photons of the wavelength associated with the actinic radiation (e.g., ultraviolet radiation, visible light) intended to be used to cure a curable composition. Norrish Type II (i.e., non-cleavable) photoinitiator moieties do not break down upon excitation, thus providing fewer possibilities for the leaching of small molecules from the matrix composition. For reference, see e.g. A. Gilbert, J. Baggott: “Essentials of Molecular Photochemistry”, Blackwell, London, 1991). Excited non-cleavable photoinitiators moieties do not break down to radicals upon excitation, but extract a hydrogen atom from an organic molecule or, more efficiently, extract an electron from an electron donor (such as an amine or a thiol). The electron transfer produces a radical anion on the photoinitiator and a radical cation on the electron donor. This is followed by proton transfer from the radical cation to the radical anion to produce two uncharged radicals; of these the radical on the electron donor is sufficiently reactive to abstract a hydrogen atom from most substrates.

The photoinitiator moiety comprises a thioxanthone moiety, an anthraquinone moiety, or a camphorquinone moiety. Thioxanthones, anthraquinones and camphorquinones are examples of Norrish Type II chromophores. Most amines with a C—H bond in α-position to the nitrogen atom and many thiols are electron donors.

In embodiments, the polymerized chromophore monomer units are (meth)acrylate monomers having a Norrish Type II chromophore moiety selected from a thioxanthone, an anthraquinone, or a camphorquinone.

In embodiments, each of the chromophore monomer units (prior to being polymerized into the backbone of the acrylic copolymer) may independently be according to formula (IV):

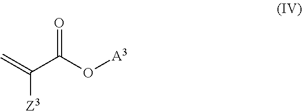

wherein
A³ is a monovalent residue comprising a Norrish Type II chromophore moiety, in particular
A³ is X or -L-X;
L is a (C₁-C₁₀) heterohydrocarbylene linker;
X is a monovalent residue of a Norrish Type II chromophore moiety selected from a thioxanthone, an anthraquinone, or a camphorquinone, preferably a thioxanthone;
Z³ is —H or —CH₃.

In embodiments, A³ of formula (IV) is X or -L-X, where L is a (C₁-C₁₀) heterohydrocarbylene linker and X is a monovalent residue of the Norrish Type II chromophore. As used in this disclosure, “residue” refers to an atom or a group of atoms that forms part of a molecule, such as a portion of a Norrish Type II chromophore. In other embodiments, A³ is a monovalent residue of the Norrish Type II chromophore. In embodiments, X may be a monovalent residue of any one of the above-discussed Norrish Type II chromophores. In embodiments, A³ is a monovalent residue comprising a thioxanthone, an anthraquinone, or a camphorquinone. In embodiments, A³ is a monovalent residue comprising a thioxanthone.

In particular, A³ of formula (I) may have the following formula (IVa) or (IVb):

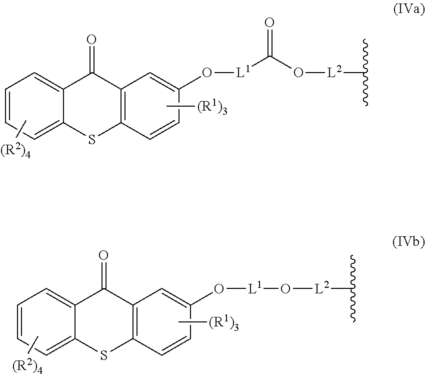

wherein, in formula (IVa) and formula (IVb):
L¹ is an alkylene;
L² is a divalent linker comprising at least 2 carbon atoms;
each R¹ and R² are independently selected from —H, halogen, alkyl, cycloalkyl, heterocycloalkyl, alkoxy, aryloxy, thioalkyl, thioaryl, alkenyl, alkynyl, aryl, aralkyl, alkaryl, heteroaryl, —C(═O)R^{a}, —NR^{b}R^{c}, alkylamino, alkylthiol, haloalkyl, —NO₂, —CN, —C(═O)OR₄, —C(—O) NR^{b}R^{c};
R^{a} is selected from an optionally substituted alkyl, an optionally substituted cycloalkyl, an optionally substituted heterocycloalkyl and an optionally substituted aryl;
R^{b}, R^{c} and R^{d} are independently selected from —H, alkyl and aryl;

In particular, in formula (IVa) and formula (IVb), R¹ and R² are independently-H, halogen, alkyl or alkoxy. More particularly, R¹ and R² are independently H or alkyl. Even more particularly R¹ and R² are independently H or methyl. More particularly still, R¹ and R² are all —H.

In formula (IVa) and formula (IVb), L¹ is an alkylene. In particular, each L¹ may independently be a linear or branched alkylene having from 1 to 6, from 1 to 4 or from 1 to 2 carbon atoms. More particularly, L¹ is-CH₂— or —CH(CH₃)—. Even more particularly, L¹ is-CH₂—.

In formula (IVa) and formula (IVb), L² is a divalent linker comprising at least 2 carbon atoms. L² may be an aromatic, aliphatic or cycloaliphatic hydrocarbon linker, a polyether linker, a polyester linker, a polycarbonate linker, a polycaprolactone linker, a polyurethane linker, a polyorganosiloxane linker, a polybutadiene linker, and combinations thereof. In particular, L² may be selected from an aromatic, aliphatic or cycloaliphatic hydrocarbon linker, a polyether linker, a polyester linker and combinations thereof.

In formula (IVa) and formula (IVb), L² may be —CH₂—CH(OH)—CH₂— or the residue of a diol. As used herein, the term “residue of a diol” means the linker obtained by removing two OH groups from a diol. Examples of suitable diols include 1,3-propylene glycol, 1,3- or 1,4-butylene glycol, 1,5-pentanediol, 1,6-hexanediol, 1,8-octanediol, 1,9-nonanediol, 1,10-decanediol, 1,12-dodecanediol, 2-methyl-1,3-propanediol, 2,2-diethyl-1,3-propanediol, 3-methyl-1,5-pentanediol, 3,3-dimethyl-1,5-pentanediol, neopentyl glycol, 2,4-diethyl-1,5-pentanediol, cyclohexanediol, cyclohexane-1,4-dimethanol, norbornene dimethanol, norbornane dimethanol, tricyclodecanediol, tricyclodecane dimethanol, bisphenol A, B, F or S, hydrogenated bisphenol A, B, F or S, di-, tri- or tetraethylene glycol, di-, tri- or tetrapropylene glycol, di-, tri- or tetrabutylene glycol, a polyethylene glycol, a polypropylene glycol, a polytetramethylene glycol, a poly(ethylene glycol-co-propylene glycol), a dianhydrohexitol (i.e. isosorbide, isomannide, isoidide), a polybutadiene polyol, a polyester polyol, a polyether polyol, a polyorganosiloxane polyol, a polycarbonate polyol as well as the alkoxylated (e.g., ethoxylated and/or propoxylated) derivatives thereof and the derivatives obtained by ring-opening polymerization of ε-caprolactone initiated with one of the aforementioned polyols.

In formula (IVa) and formula (IVb), L² may be —CH₂—CH(OH)—CH₂— or a divalent linker selected from one of formulas (A)-(E):

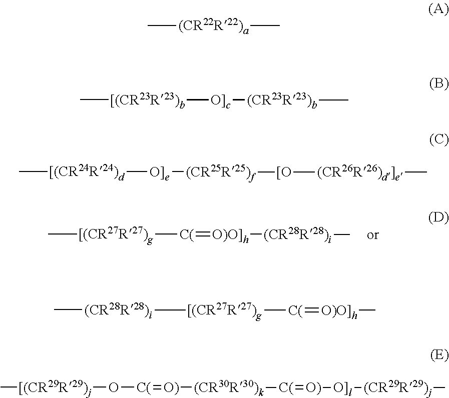

wherein
   R²², R′²², R²⁵, R′²⁵, R²⁹, R′²⁹, R³⁰ and R′³⁰ are independently H or alkyl;
   R²³, R′²³, R²⁴, R′²⁴, R²⁶, R′²⁶, R²⁷, R′²⁷, R²⁸ and R′²⁸ are independently H or methyl;
   a is 2 to 20;
   b, d, and d′ are independently 2 to 4;
   c is 1 to 20;
   e and e′ are independently 0 to 20 with the proviso that at least one of q and
   q′ is not 0;
   f is 2 to 20;
   g is 3 to 12;
   h is 1 to 20;
   i is 2 to 8;
   j is 2 to 20;
   k is 2 to 30;
   l is 1 to 20.

In particular, in formula (IVa) and formula (IVb), L² may be —CH₂—CH(OH)—CH₂— or a divalent linker selected from an alkylene such as 1,3-propanediyl, 1,3- or 1,4-butanediyl, 1,5-pentanediyl, 1,6-hexanediyl, 1,8-octanediyl, 1,9-nonanediyl, 1,10-decanediyl, 1,12-decanediyl, 2-methyl-1,3-propanediyl, 2,2-diethyl-1,3-propanediyl, 3-methyl-1,5-pentanediyl, 3,3-dimethyl-1,5-pentanediyl, 2,2-dimethyl-1,3-propanediyl, 2,4-diethyl-1,5-pentanediyl; an alkoxylated (in particular an ethoxylated and/or propoxylated) derivative of the aforementioned alkylenes; an esterified (in particular by ring-opening polymerization of a lactone such as ε-caprolactone) derivative of the aforementioned alkylenes; a residue of a di-, tri-, tetra- or polyoxyalkene without the OH groups such as di-, tri- or tetraethylene glycol, di-, tri- or tetrapropylene glycol, di-, tri- or tetrabutylene glycol, polyethylene glycol, polypropylene glycol, polybutylene glycol, poly(ethylene glycol-co-propylene glycol).

In a preferred embodiment, A³ of formula (I) is according to one of the following formulas (IVc) or (IVd):

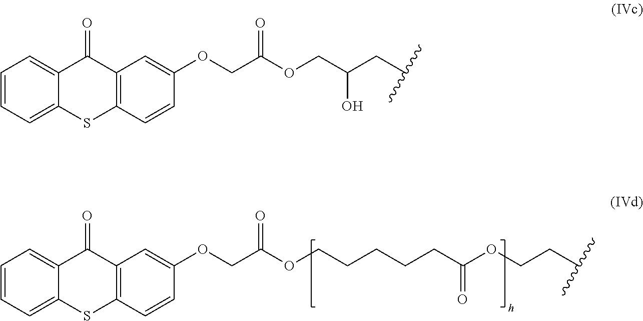

wherein h is 1 to 20.

Other suitable linker groups may be used, including others not having a carbonyl group.

All of the embodiments described above for A³ of formula (IV) equally apply to A³ in the acrylic copolymer of formula (I).

The weight fraction of the polymerized chromophore monomer units in the acrylic copolymer may be varied based on factors that are known in the art, such as desired cure time among other factors. As described herein, p of formula (I) is a weight fraction of the polymerized chromophore monomer. In embodiments, p is greater than or equal to 0.001, such as greater than or equal to 0.005, or greater than or equal to 0.01. In embodiments, p is from 0.001 to 0.40, from 0.001 to 0.30, from 0.001 to 0.20, from 0.001 to 0.10, from 0.001 to 0.05, from 0.001 to 0.03, from 0.005 to 0.40, from 0.005 to 0.30, from 0.005 to 0.20, from 0.005 to 0.10, from 0.005 to 0.05, from 0.005 to 0.03, or from 0.005 to 0.02.

It should be understood that, when the acrylic copolymer includes more than one discrete type of polymerized chromophore monomer, the weight fraction p of the polymerized chromophore monomers in the acrylic copolymer equals the sum of the individual weight fractions of every discrete type of polymerized chromophore monomer. Furthermore, it should be understood that, even if a chromophore monomer may be characterized based on T_{g} alone as a high T_{g} monomer or a low T_{g} monomer, any monomer including a chromophore moiety is considered to be neither a high T_{g} monomer nor a low T_{g} monomer with respect to calculating the weight fractions m and n in formula (I).

### Additional Monomer Units

The acrylic copolymers disclosed herein optionally include polymerized additional monomer units. The additional monomer units can include monomer units that are copolymerized with the high-Tg monomer units, the low-Tg monomer units, and the chromophore monomer units. The additional monomer units are distinct from the high-Tg monomer units, the low-Tg monomer units and the chromophore monomer units.

The additional monomer units may comprise a functional group selected from a polymerizable group other than a (meth)acrylate group (i.e. a vinyl group, an allyl group, a conjugated diene group, an alkenyl group), an acidic group (i.e. a carboxylic acid group, a phosphonic acid (—P(═O)(OH)₂) group, a phosphonate (—P(═O)(OR)₂) group, a sulfonic acid (—S(═O)₂OH) group, a sulfonate (—S(═O)₂OR) group, a phosphate (—O—P(═O)(OR)₂) group, wherein each R is independently a counterion, a hydrogen atom, or an optionally substituted hydrocarbyl), a nitrogen-containing group (i.e. an amino group, a cyano group or a heterocycle with one or more nitrogen ring atoms), a hydroxyl group, an epoxy group, a carbonyl group, an acetoacetoxy group, an acetoacetamide group, a 1,1-dimethyl-3-oxobuyl (diacetone) group, a thiol group, a silane group, an ether bond, an ester bond (not comprised in a (meth)acrylate group) and combinations thereof.

Preferably, the additional monomer units comprise a functional group selected from an acidic group and a nitrogen-containing group. More preferably, the additional monomer units comprise a functional group selected from a carboxylic acid group, a tertiary amine group, or a heterocycle with one or more nitrogen ring atoms.

It should be highlighted that (meth)acrylic acid corresponds to an additional monomer. Accordingly, the amount by weight of polymerized (meth)acrylic acid units, if present, should be taken into account in the total amount of polymerized additional monomer monomer units and not in the total amount of polymerized high-T_{g} monomer units.

In embodiments, the additional monomer units can include other unsaturated monomer units (other than (meth)acrylic monomer units), such as vinyl amides, vinyl ethers, vinyl esters, vinyl oxazolidinones, (meth)acrylamides, and combinations thereof. In embodiments, the additional monomer units can include other monomer units that are polymerized in the acrylic copolymer such as styrene derivatives and maleimides.

In embodiments, the additional monomer units can comprise epoxy, ether, ester, acid, or ketone functionality that are not polymerized in the acrylic copolymer. For example, the additional monomer units may comprise a caprolactone-extended acrylate (SR49B, Sartomer), cyclic trimethylolpropane formal acrylate (SR531, Sartomer) propoxylated tetrahydrofurfuryl acrylate (SR611, Sartomer), beta-carboxyethylacrylate, glycidyl methacrylate, or 2-(2-ethoxyethoxy)ethyl acrylate (SR256), neopentyl monomethacrylate, tetrahydrofurfuryl (meth)acrylate, phenoxyethyl acrylate, 2-hydroxypropyl (meth)acrylate, 2-hydroxyethyl (meth)acrylate, 2-cyanobutyl acrylate, 4-cyanobutyl acrylate, 2-cyanoethyl acrylate, cyanomethyl acrylate, and combinations thereof.

In embodiments, the additional monomer units can be a monomer that acts synergistically with the polymerized chromophore monomer units and/or reduce oxygen inhibition. Oxygen inhibition may limit surface curing and hence limit the performances of a resulting cured product.

Common synergist functionality that functions as a synergist for a Type II photoinitiator may include an acidic group, a heterocycle with one or more nitrogen ring atoms, tertiary amine functionality, alkylenoxy functionality (i.e. one or more oxyalkylene units), mercaptan groups, or other sources of readily abstractable hydrogen. Typical addditional monomer units which contain synergist functionality are exemplified by monomers such as (meth)acrylic acid, dimethylaminoethylacrylate (DMAEA), dimethylaminoethylmethacrylate (DMAEMA), diethylaminoethyl acrylate (DEAEA), diethylaminoethyl methacrylate (DEAEMA), N-vinylpyrrolidone (NVP), N-vinylcaprolactam (VCAP), acryloxymorpholine (ACMO), dimethyl acrylamide (DMAC), a poly(ethylenoxide) mono(meth)acrylate, hydroxyethyl ethylene urea (meth)acrylate (HEEU (M) A), the reaction product of a cyclic anhydride with a hydroxy-functional (meth)acrylate, and combinations thereof.

In embodiments, the additional monomer units can comprise an amine synergist. Some examples of amine synergists include tertiary amines. When an amine-synergist containing monomer is included in the acrylic copolymer in conjunction with the Norrish Type II chromophore of the polymerized chromophore monomer unit, the tertiary amine provides an active hydrogen donor site for the excited triplet state of the chromophore, thus producing a reactive alkyl-amino radical that subsequently can initiate polymerization. Tertiary amines are also able to convert unreactive peroxy species, formed by reaction between oxygen and free radicals, to reactive alkyl-amino radicals, thus reducing the effects of oxygen on curing. Examples of amine synergists that may be a component of the polymerized additional monomer include low-molecular weight tertiary amines (i.e. tertiary amines having a molecular weight of less than 200 g/mol) such as triethanol amine, N-methyldiethanol amine. Other types of amine synergists are aminobenzoates, polymerizable aminobenzoates, polymeric aminobenzoates and mixtures thereof. Examples of aminobenzoates include ethyl 4-(dimethylamino)benzoate (EDB), pentyl 4-(dimethylamino)benzoate, 2-ethylhexyl 4-(dimethylamino)benzoate and 2-butoxyethyl 4-(dimethylamino)benzoate (BEDB).

In embodiments, the additional monomer units are (meth)acrylate monomers having a pendent amine functionality.

Any of the above-discussed synergists or amine-based synergists may be the pendent residue in the additional monomer units of the acrylic copolymers herein.

In embodiments, each of the additional monomer units (prior to being polymerized into the backbone of the acrylic copolymer) may independently be according to formula (V):

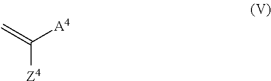

where:
   A⁴ is a (C₁-C₃₀) hydrocarbyl or (C₁-C₃₀) heterohydrocarbyl, preferably a (C₁-C₃₀) heterohydrocarbyl bearing a functional group selected from an acidic group, a nitrogen-containing group, a hydroxyl group, an epoxy group, a carbonyl group, an acetoacetoxy group, an acetoacetamide group, a 1,1-dimethyl-3-oxobuyl (diacetone) group, a thiol group, a silane group, an ether bond, an ester bond, and combinations thereof
   Z⁴ is —H or —CH₃.

A⁴ may comprise a monovalent residue of any one of the above-discussed synergists. In embodiments, Z⁴ is —H or —CH₃ and A⁴ is-C(═O)—O—R⁴ wherein R⁴ is selected from H, dimethylaminomethyl, dimethylaminoethyl, morpholino, dimethylamino, —CH₂—CH₂-imidazolidinone, or combinations thereof. In embodiments, Z⁴ is —H and A⁴ comprises a heterocycle bearing one or more nitrogen ring atoms, for example A⁴ may correspond to one of the following formulae:

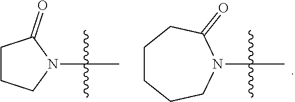 [SMILES: *N1CCCC1=O ; *N1CCCCCC1=O]

Said embodiments equally apply to A⁴ and Z⁴ in the acrylic copolymer of formula (I).

The weight fraction of the polymerized additional monomers in the acrylic copolymer can vary depending on factors well-known in the art, such as desired cure time and desired extent of cure. As described herein, q of formula (I) is a weight fraction of the additional monomer. In embodiments, q is 0. In other embodiments, q is greater than or equal to 0.001, such as greater than or equal to 0.005, or greater than or equal to 0.01. In embodiments, q is from 0.001 to 0.20, from 0.001 to 0.10, from 0.001 to 0.05, from 0.001 to 0.03, from 0.005 to 0.20, from 0.005 to 0.10, from 0.005 to 0.05, from 0.005 to 0.03, or from 0.005 to 0.02.

Preferably, q is from 0 to 0.10.

Acrylic copolymers described herein can be formed by controlled polymerization of the high-T_{g} monomer units, the low-T_{g} monomer units, the chromophore monomer units, and optionally, the additional monomers. Common methods known in the art, such as but not limited to solution acrylic polymerization can be used to form the acrylic copolymers.

### Properties of the Acrylic Copolymer

Acrylic copolymers described herein can be formed by polymerization of the different monomer units (i.e. the high-T_{g} monomer units, the low-T_{g} monomer units, the chromophore monomer units, and optionally, the at least one additional monomer unit). Common methods known in the art include, but are not limited, to solution polymerization. Accordingly, the acrylic copolymer may be obtained by polymerizing the different monomer units dissolved in a non-reactive solvent in the presence of an initiator. The solution polymerization may be conducted at a temperature of at least 50° C., preferably at least 60° C. Examples of suitable non-reactive solvents include toluene, heptane, ethyl acetate, methyl ethyl ketone (MEK), isopropanol and combinations thereof. The initiator may be a thermal initiator. Thermal initiators are well known in the art and include, for example, peroxides (i.e., a compound comprising an oxygen-oxygen single bond), especially inorganic persulfate compounds such as ammonium persulfate, potassium persulfate and sodium persulfate; hydrogen peroxide; organic peroxides such as cumene hydroperoxide, t-butyl hydroperoxide, acetyl peroxide, benzoyl peroxide, lauroyl peroxide; peracids such as peracetic acid and perbenzoic acid; redox initiators wherein a reducing agent such as a ferrous compound promotes the decomposition of a peroxide; as well as other free radical producing materials such as an azo-initiator (i.e., a compound comprising an nitrogen-nitrogen double bond), for example 2,2′-azobisisobutyronitrile, 4,4′-azobis(4-cyanovaleric acid) or 2,2′-azobis(2-methylbutyronitrile); and combinations thereof. The initiator may be added in an amount such that the total monomer:initiator weight ratio is from 100:1 to 1000:1 The solution polymerization typically provides a mixture of the acrylic copolymer dissolved in the non-reactive solvent. The non-reactive solvent may be eliminated by heating. A reactive diluent may be added prior to the elimination of the non-reactive solvent to form a curable composition as detailed below At the end of the solution polymerization (i.e. prior to the introduction of the reactive diluent) the mixture may have a solids content of from 25% to 70%, preferably from 30% to 50%, by weight based on the total weight of the mixture. Said mixture may have a residual amount of monomers that is less than 2%, in particular less than 1%, more particularly less than 0.5%, by weight based on the total weight of the mixture. The experimental parameters of the solution polymerization (i.e. solids content, reaction temperature, reaction time and total monomer:initiator ratio) can be adjusted to produce acrylic copolymers of relatively low molecular weights using experimental conditions well known by those skilled in the art.

Preferably, the acrylic copolymer is not obtained by telomerization, i.e. in the presence of a telogen compound (i.e. a compound bearing at least one cleavable bond selected from C—H, S—H, P—H, Si—H or C—X, where X═Cl, Br or I) such as tetrabromomethane (CBr₄), bromotrichloromethane (CBrCl₃), dibromodichloromethane (CBr₂Cl₂), a mercaptan, hydrogen disulfide.

In embodiments, the acrylic copolymer may have a weight average molecular weight of at least 10,000 grams per mole (g/mol). In embodiments, the acrylic copolymer may have a weight average molecular weight from 10,000 g/mol to 600,000 g/mol. In embodiments, the acrylic copolymer may have a weight average molecular weight equal to or greater than 10,000 g/mol, equal to or greater than 25,000 g/mol, or even equal to or greater than 50,000 g/mol. In embodiments, the acrylic copolymer may have a weight average molecular weight equal to or less than 600,000 g/mol, equal to or less than 500,000 g/mol, equal to or less than 400,000 g/mol, equal to or less than 300,000 g/mol, equal to or less than 200,000 g/mol, or even equal to or less than 100,000 g/mol. In embodiments, the acrylic copolymer may have a weight average molecular weight from 10,000 g/mol to 600,000 g/mol, from 10,000 g/mol to 500,000 g/mol, from 10,000 g/mol to 400,000 g/mol, from 10,000 g/mol to 300,000 g/mol, from 10,000 g/mol to 200,000 g/mol, from 10,000 g/mol to 100,000 g/mol, from 25,000 g/mol to 600,000 g/mol, from 25,000 g/mol to 500,000 g/mol, from 25,000 g/mol to 400,000 g/mol, from 25,000 g/mol to 300,000 g/mol, from 25,000 g/mol to 200,000 g/mol, from 25,000 g/mol to 100,000 g/mol, from 50,000 g/mol to 600,000 g/mol, from 50,000 g/mol to 500,000 g/mol, from 50,000 g/mol to 400,000 g/mol, from 50,000 g/mol to 300,000 g/mol, from 50,000 g/mol to 200,000 g/mol, or even from 50,000 g/mol to 100,000 g/mol, or any and all subranges formed from any of these endpoints.

In a preferred embodiment, the acrylic copolyer may have a weight average molecular weight of from 10,000 g/mol to 100,000 g/mol, in particular from 10,000 g/mol to 90,000 g/mol, in particular from 11,000 g/mol to 80,000 g/mol, more particularly from 12,000 g/mol to 75,000 g/mol, even more particularly from 15,000 g/mol to 70,000 g/mol, more particularly still from 15,000 g/mol to 65,000 g/mol.

In embodiments, the acrylic copolymer may have a glass transition temperature T_{g} equal to or less than −10° C. to ensure the curable composition is suitable for certain applications, such as use as a pressure sensitive adhesive. In embodiments, the acrylic copolymer may have a T_{g} equal to or less than −10° C., such as equal to or less than −15° C., equal to or less than −20° C., equal to or less than −25° C., or even equal to or less than −30° C. In embodiments, the acrylic copolymer may have a T_{g} equal to or greater than −120° C., equal to or greater than −100° C., equal to or greater than −80° C., or even equal to or greater than −60° C. In embodiments, the acrylic copolymer may have a T_{g} from −10° C. to −120° C., from −10° C. to −100° C., from −10° C. to −80° C., from −10° C. to −60° C., from −15° C. to −120° C., from −15° C. to −100° C., from −15° C. to −80° C., from −15° C. to −60° C., from −20° C. to −120° C., from −20° C. to −100° C., from −20° C. to −80° C., from −20° C. to −60° C., from −25° C. to −120° C., from −25° C. to −100° C., from −25° C. to −80° C., from −25° C. to −60° C., from −30° C. to −120° C., from −30° C. to −100° C., from −30° C. to −80° C., or even from −30° C. to −60° C., or any and all subranges formed from any of these endpoints.

In embodiments, the acrylic copolymer has formula (V):

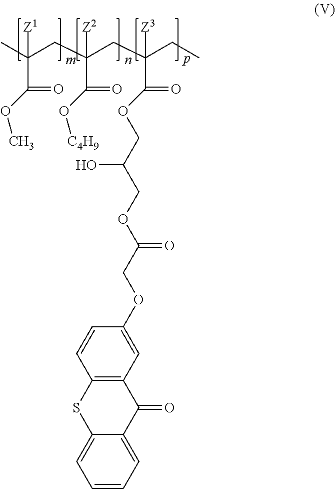

where m is from 0.2 to 0.8, n is from 0.1 to 0.8, p is from 0.001 to 0.2, and q is from 0 to 0.2.

In embodiments where q is greater than 0, Z¹, Z², Z³, and Z⁴ are independently-H or —CH₃. For instance, in embodiments where q is greater than 0, Z¹ is-CH₃ and Z², Z³, and Z⁴ are —H. In embodiments where q is equal to 0, Z¹, Z², and Z³ are independently-H or —CH₃. For instance, in embodiments where q is greater than 0, Z¹ is-CH₃ and Z² and Z³ are —H.

### Curable Composition

In embodiments, a curable composition can comprise at least one of the acrylic copolymers described herein. In embodiments, the curable composition may not include any additional photoinitiators, other than the polymerized chromophore monomer units of the acrylic copolymer. That is, in embodiments, the acrylic copolymer can be cured upon irradiation without any additional photoinitiators. In other embodiments, the curable composition can comprise one or more photoinitiators in addition to the polymerized chromophore monomer units of the acrylic copolymer. In a preferred embodiment, the curable composition may be substantially free of a photoinitiator other than the acrylic copolymer of the present invention. In particular, the curable composition may comprise less than 0.1%, in particular less than 0.05%, more particularly less than 0.001%, even more particularly 0% by weight of photoinitiator other than the acrylic copolymer of the present invention.

Preferably, the curable composition does not comprise a (meth)acrylic copolymer other than the acrylic copolymer of the invention.

In embodiments, the curable composition can comprise one or more (meth)acrylate monomers or oligomers, diluents, (meth)acrylate oligomers, amine synergists, fillers, photoinitiators, slip agents, thickeners, slip agents, hindered amine light stabilizers, ultraviolet absorbing monomers, or other auxiliary additives.

In some embodiments, the at least one (meth)acrylate oligomer is included and is chosen from at least one of urethane acrylate and urethane methacrylate, and the at least one (meth)acrylate monomer is included and is chosen from at least one of 2-hydroxyethyl methacrylate and isobornyl methacrylate.

In a preferred embodiment, the curable composition comprises the acrylic copolymer according to the invention and a reactive diluent. The reactive diluent may be used with or completely replace a non-reactive solvent used to prepare the acrylic copolymer.

In embodiments, the reactive diluent may have a viscosity equal to or less than 3000 cP, as measured by Brookfield DV-III viscometer using Spindle SC-27 at 25° C., such as equal to or less than 2750 cP, equal to or less than 2500 cP, equal to or less than 2250 cP, equal to or less than 2000 cP, equal to or less than 1750 cP, equal to or less than 1500 cP, or even equal to or less than 1250. In embodiments, the reactive diluent may have a viscosity equal to or greater than 5 cP, as measured by Brookfield DV-III viscometer using Spindle SC-27 at 25° C., such as equal to or greater than 25 cP, equal to or greater than 50 cP, equal to or greater than 100 cP, equal to or greater than 250 cP, equal to or greater than 500 cP, equal to or greater than 750 cP, or even equal to or greater than 1000 cP. In embodiments, the reactive diluent may have a viscosity, as measured by Brookfield DV-III viscometer using Spindle SC-27 at 25° C., from 25 cP to 3000 cP, from 25 cP to 2750 cP, from 25 cP to 2500 cP, from 25 cP to 2250 cP, from 25 cP to 2000 cP, from 25 cP to 1750 cP, from 25 cP to 1500 cP, from 25 cP to 1250 cP, from 25 cP to 3000 cP, from 25 cP to 2750 cP, from 25 cP to 2500 cP, from 25 cP to 2250 cP, from 25 cP to 2000 cP, from 25 cP to 1750 cP, from 25 cP to 1500 cP, from 25 cP to 1250 cP, from 50 cP to 3000 cP, from 50 cP to 2750 cP, from 50 cP to 2500 cP, from 50 cP to 2250 cP, from 50 cP to 2000 cP, from 50 cP to 1750 cP, from 50 cP to 1500 cP, from 50 cP to 1250 cP, from 100 cP to 3000 cP, from 100 cP to 2750 cP, from 100 cP to 2500 cP, from 100 cP to 2250 cP, from 100 cP to 2000 cP, from 100 cP to 1750 cP, from 100 cP to 1500 cP, from 100 cP to 1250 cP, from 250 cP to 3000 cP, from 250 cP to 2750 cP, from 250 cP to 2500 cP, from 250 cP to 2250 cP, from 250 cP to 2000 cP, from 250 cP to 1750 cP, from 250 cP to 1500 cP, from 250 cP to 1250 cP, from 500 cP to 3000 cP, from 500 cP to 2750 cP, from 500 cP to 2500 cP, from 500 cP to 2250 cP, from 500 cP to 2000 cP, from 500 cP to 1750 cP, from 500 cP to 1500 cP, from 500 cP to 1250 cP, from 750 cP to 3000 cP, from 750 cP to 2750 cP, from 750 cP to 2500 cP, from 750 cP to 2250 cP, from 750 cP to 2000 cP, from 750 cP to 1750 cP, from 750 cP to 1500 cP, from 750 cP to 1250 cP, from 1000 cP to 3000 cP, from 1000 cP to 2750 cP, from 1000 cP to 2500 cP, from 1000 cP to 2250 cP, from 1000 cP to 2000 cP, from 1000 cP to 1750 cP, from 1000 cP to 1500 cP, or even from 1000 cP to 1250 cP, or any and all subranges formed from any of these endpoints.

The reactive diluent may comprise at least one radically polymerizable diluent. The reactive diluent may comprise a mixture of radically polymerizable diluents. When the reactive diluent comprises a mixture of radically polymerizable diluents, the embodiment relating to the viscosity applies to the mixture of the radically polymerizable diluents.

As used herein, a radically polymerizable diluent is a compound having at least one polymerizable carbon-carbon double bond and preferably a suitable viscosity as defined above. A polymerizable carbon-carbon double bond is capable of participating in a free radical polymerization wherein at least one of the carbon atoms of the double bond becomes covalently bonded to another atom, in particular a carbon atom, in a second molecule. In particular, the reactive diluent may comprise at least one radically polymerizable diluent selected from a (meth)acrylate, a vinyl ether, a vinyl amide, a vinyl oxazolidinone, and combinations thereof. These diluents can be monofunctional (i.e. bear a single polymerizable carbon-carbon double bond) or multifunctional (i.e. bear at least two polymerizable carbon-carbon double bonds). These diluents can be selected to provide targeted final properties of the cured formulations as long as they provide adequate viscosity reduction of the acrylic copolymer while also producing adequate properties when curable composition is cured.

The reactive diluent may comprise a monofunctional (meth)acrylate (i.e. a monomer bearing a single (meth)acrylate group). Examples of suitable monofunctional (meth)acrylates include mono-(meth)acrylate esters of aliphatic alcohols (wherein the aliphatic alcohol may be straight chain, branched or alicyclic and may be a mono-alcohol, a di-alcohol or a polyalcohol, provided only one hydroxyl group is esterified with (meth)acrylic acid); mono-(meth)acrylate esters of aromatic alcohols (such as phenols, including alkylated phenols); mono-(meth)acrylate esters of alkylaryl alcohols (such as benzyl alcohol); mono-(meth)acrylate esters of oligomeric and polymeric glycols such as diethylene glycol, triethylene glycol, dipropylene glycol, tripropylene glycol, polyethylene glycol, and polypropylene glycol); mono-(meth)acrylate esters of monoalkyl ethers of glycols and oligoglycols; mono-(meth)acrylate esters of alkoxylated (e.g., ethoxylated and/or propoxylated) aliphatic alcohols (wherein the aliphatic alcohol may be straight chain, branched or alicyclic and may be a mono-alcohol, a di-alcohol or a polyalcohol, provided only one hydroxyl group of the alkoxylated aliphatic alcohol is esterified with (meth)acrylic acid); mono-(meth)acrylate esters of alkoxylated (e.g., ethoxylated and/or propoxylated) aromatic alcohols (such as alkoxylated phenols); caprolactone mono(meth)acrylates; and the like. The following compounds are specific examples of mono(meth)acrylate-functionalized monomers suitable for use: methyl (meth)acrylate; ethyl (meth)acrylate; n-propyl (meth)acrylate; n-butyl (meth)acrylate; isobutyl (meth)acrylate; n-hexyl (meth)acrylate; 2-ethylhexyl (meth)acrylate; n-octyl (meth)acrylate; isooctyl (meth)acrylate; n-decyl (meth)acrylate; n-dodecyl (meth)acrylate; tridecyl (meth)acrylate; tetradecyl (meth)acrylate; hexadecyl (meth)acrylate; 2-hydroxyethyl (meth)acrylate; 2- and 3-hydroxypropyl (meth)acrylate; 2-methoxyethyl (meth)acrylate; 2-ethoxyethyl (meth)acrylate; 2- and 3-ethoxypropyl (meth)acrylate; tetrahydrofurfuryl (meth)acrylate; alkoxylated tetrahydrofurfuryl (meth)acrylate; 2-(2-ethoxyethoxy)ethyl (meth)acrylate; cyclohexyl (meth)acrylate; glycidyl (meth)acrylate; isodecyl (meth)acrylate; lauryl (meth)acrylate; 2-phenoxyethyl (meth)acrylate; alkoxylated phenol (meth)acrylates; alkoxylated nonylphenol (meth)acrylates; cyclic trimethylolpropane formal (meth)acrylate; isobornyl (meth)acrylate; tricyclodecanemethanol (meth)acrylate; tert-butylcyclohexanol (meth)acrylate; trimethylcyclohexanol (meth)acrylate; diethylene glycol monomethyl ether (meth)acrylate; diethylene glycol monoethyl ether (meth)acrylate; diethylene glycol monobutyl ether (meth)acrylate; triethylene glycol monoethyl ether (meth)acrylate; ethoxylated lauryl (meth)acrylate; methoxy polyethylene glycol (meth)acrylates; hydroxyl ethyl-butyl urethane (meth)acrylates; 3-(2-hydroxyalkyl) oxazolidinone (meth)acrylates; and combinations thereof.

The reactive diluent may comprise a monofunctional (meth)acrylate bearing one or more of the following groups: a ring or ring system (i.e. one or more rings selected from aromatic rings and/or (hetero)cycloaliphatic rings which may be fused and/or bridged), a C₇-C₂₀ hydrocarbon chain (i.e. a linear or branched chain bearing only carbon and hydrogen atoms wherein the number of carbon atoms in the chain is from 7 to 20), one or more oxyalkylene units (such as oxyethylene, oxypropylene and/or oxybutylene units), one or more ester units derived from the ring-opening of a lactone (such as ε-caprolactone) and combinations thereof. Examples of such monofunctional (meth)acrylates are isobornyl (meth)acrylate, tetrahydrofurfuryl (meth)acrylate, phenol (meth)acrylate, nonylphenol (meth)acrylate, octyl (meth)acrylate, isooctyl (meth)acrylate, 2-ethylhexyl (meth)acrylate, decyl (meth)acrylate, isodecyl (meth)acrylate; lauryl (meth)acrylate; tridecyl (meth)acrylate, stearyl (meth)acrylate, a (poly) caprolactone mono(meth)acrylate, di-, tri-, tetra- or polyethylene glycol mono(meth)acrylate, di-, tri-, tetra- or polyethylene glycol monomethyl ether (meth)acrylate, di-, tri-, tetra- or polyethylene glycol monoethyl ether (meth)acrylate, as well as the alkoxylated (i.e. ethoxylated and/or propoxylated) derivatives thereof, and combinations thereof.

The reactive diluent may comprise a monofunctional (meth)acrylate monomer having a T_{g} that is higher than 25° C., preferably higher than 30° C., more preferably higher than 35° C., even more preferably higher than 40° C., more preferably still higher than 45° C., more preferably yet higher than 50° C. Examples of such monomers include 2-phenylethyl methacrylate, neopentyl methacrylate, 3,3,5-trimethylcyclohexyl acrylate, tert-butyl acrylate, octadecyl methacrylate, octadecyl acrylate, glycidyl methacrylate, propyl methacrylate, tetrahydrofurfuryl methacrylate, benzyl methacrylate, isobutyl methacrylate, glycidyl methacrylate, ethyl methacrylate, 2,2,3,3-tetrafluoropropyl methacrylate, 2-hydroxypropyl methacrylate, 2,2,2-trifluoroethyl methacrylate, 2-hydroxyethyl methacrylate, isopropyl methacrylate, isobornyl acrylate, methyl methacrylate, butyl cyanoacrylate, isobornyl methacrylate, phenyl methacrylate, 2-cyanobutyl acrylate, tert-butyl methacrylate, cyclohexyl acrylate, cyclohexyl methacrylate, 4-tert-butylcyclohexyl acrylate, 4-tert-butylcyclohexyl methacrylate, ethyl cyanoacrylate, methyl cyanoacrylate, 3,3,5-trimethylcyclohexyl acrylate, 3,3,5-trimethylcyclohexyl methacrylate, a substituted or unsubstituted (C₆-C₁₂) cycloalkyl (meth)acrylate, adamantyl (meth)acrylate, dicyclopentanyl (meth)acrylate, tricyclodecane methanol mono(meth)acrylate, 2-phenoxyethyl methacrylate, or combinations thereof.

The reactive diluent may comprise a polyfunctional (meth)acrylate (i.e. a monomer bearing at least two (meth)acrylate groups), such as bisphenol A di(meth)acrylate; hydrogenated bisphenol A di(meth)acrylate; ethylene glycol di(meth)acrylate; diethylene glycol di(meth)acrylate; triethylene glycol di(meth)acrylate; tetraethylene glycol di(meth)acrylate; polyethylene glycol di(meth)acrylate; propylene glycol di(meth)acrylate; dipropylene glycol di(meth)acrylate; tripropylene glycol di(meth)acrylate; tetrapropylene glycol di(meth)acrylate; polypropylene glycol di(meth)acrylate; polytetramethylene glycol di(meth)acrylate; 1,2-butanediol di(meth)acrylate; 2,3-butanediol di(meth)acrylate; 1,3-butanediol di(meth)acrylate; 1,4-butanediol di(meth)acrylate; 1,5-pentanediol di(meth)acrylate; 1,6-hexanediol di(meth)acrylate; 1,8-octanediol di(meth)acrylate; 1,9-nonanediol di(meth)acrylate; 1,10-nonanediol di(meth)acrylate; 1,12-dodecanediol di(meth)acrylate; neopentyl glycol di(meth)acrylate; 2-methyl-2,4-pentanediol di(meth)acrylate; polybutadiene di(meth)acrylate; cyclohexane-1,4-dimethanol di(meth)acrylate; tricyclodecane dimethanol di(meth)acrylate; metallic di(meth)acrylates; modified metallic di(meth)acrylates; glyceryl di(meth)acrylate; glyceryl tri(meth)acrylate; trimethylolethane tri(meth)acrylate; trimethylolethane di(meth)acrylate; trimethylolpropane tri(meth)acrylate; trimethylolpropane di(meth)acrylate; pentaerythritol di(meth)acrylate; pentaerythritol tri(meth)acrylate; pentaerythritol tetra(meth)acrylate, di(trimethylolpropane) diacrylate; di(trimethylolpropane) triacrylate; di(trimethylolpropane) tetraacrylate, sorbitol penta (meth)acrylate; di(pentaerythritol) tetraacrylate; di(pentaerythritol) pentaacrylate; di(pentaerythritol) hexa(meth)acrylate; tris(2-hydroxyethyl) isocyanurate tri(meth)acrylate; as well as the alkoxylated (e.g., ethoxylated and/or propoxylated) derivatives thereof; and combinations thereof.

The reactive diluent may comprise a vinyl ether such as dodecyl vinyl ether, hydroxybutyl vinyl ether, cyclohexanedimethylol divinyl ether, and DVE-3 (triethylene glycol divinyl ether) and combinations thereof.

The reactive diluent may comprise a vinyl amide such as N-vinylpyrrolidone (NVP), N-vinyl caprolactam (V-CAP) and combinations thereof.

The reactive diluent may comprise a vinyl oxazolidinone such as vinyl methyl oxazolidinone (VMOX).

In a preferred embodiment the reactive diluent preferably comprises a monofunctional (meth)acrylate, a polyfunctional (meth)acrylate or a mixture of a monofunctional (meth)acrylate and a polyfunctional (meth)acrylate.

The amount of reactive diluent in the curable composition will vary depending on the desired viscosity. In embodiments, the curable composition may comprise, based on a weight of the curable composition, from 20% to 80% by weight of the reactive diluent. In embodiments, the curable composition may comprise, based on a weight of the curable composition, equal to or greater than 20%, equal to or greater than 25%, equal to or greater than 30%, equal to or greater than 35%, or even equal to or greater than 40%, by weight of the reactive diluent. In embodiments, the curable composition may comprise, based on a weight of the curable composition, equal to or less than 80%, equal to or less than 75%, equal to or less than 70%, equal to or less than 65%, or even equal to or less than 60%, by weight of the reactive diluent. In embodiments, the amount by weight of the reactive diluent in the curable composition, based on the total weight of the curable composition, may be from 20% to 80%, from 20% to 75%, from 20% to 70%, from 20% to 75%, from 20% to 60%, from 25% to 80%, from 20% to 75%, from 25% to 70%, from 25% to 75%, from 25% to 60%, from 30% to 80%, from 30% to 75%, from 30% to 70%, from 30% to 75%, from 30% to 60%, from 35% to 80%, from 35% to 75%, from 35% to 70%, from 35% to 75%, from 35% to 60%, from 40% to 80%, from 40% to 75%, from 40% to 70%, from 40% to 75%, or even from 40% to 60%, or any and all subranges formed from any of these endpoints.

In a preferred embodiment the curable composition, may comprise at least 5%, at least 10%, at least 15%, at least 20%, at least 30%, at least 40% or at least 50% by weight of a monofunctional (meth)acrylate monomer as defined above, based on the total weight of the curable composition. Alternatively, the curable composition, may comprise less than 5%, less than 4%, less than 3%, less than 2%, less than 1% or even 0% by weight of a monofunctional (meth)acrylate monomer as defined above, based on the total weight of the curable composition.

In a preferred embodiment the curable composition, may comprise at least 5%, at least 10%, at least 15%, at least 20%, at least 30%, at least 40% or at least 50% by weight of a polyfunctional (meth)acrylate monomer as defined above, based on the total weight of the curable composition. Alternatively, the curable composition, may comprise less than 5%, less than 4%, less than 3%, less than 2%, less than 1% or even 0% by weight of a polyfunctional (meth)acrylate monomer as defined above, based on the total weight of the curable composition.

In embodiments, a weight ratio of the acrylic copolymer to the reactive diluent in the curable composition may be from 4:1 to 1:4, such as from 3:1 to 1:4, from 2:1 to 1:4, from 1:1 to 1:4, from 3:1 to 1:3, from 2:1 to 1:3, from 1:1 to 1:3, from 3:1 to 1:2, from 2:1 to 1:2, from 1:1 to 1:2, from 3:1 to 1:1, or even from 2:1 to 1:1, or any and all subranges formed from any of these endpoints.

In a preferred embodiment, the curable composition comprises the acrylic copolymer according to the invention and a (meth)acrylate-functionalized oligomer.

A (meth)acrylate-functionalized oligomer may be selected in order to enhance the flexibility, strength and/or modulus, among other attributes, of a cured polymer prepared by curing the curable composition of the invention.

A (meth)acrylate functionalized oligomer may have 1 to 18 (meth)acrylate groups, in particular 2 to 6 (meth)acrylate groups, more particularly 2 to 6 acrylate groups.

A (meth)acrylate functionalized oligomer may have a number average molecular weight equal or more than 600 g/mol, in particular 800 to 15,000 g/mol, more particularly 1,000 to 5,000 g/mol.

In particular, the curable composition may comprise a (meth)acrylate-functionalized oligomer selected from the group consisting of epoxy (meth)acrylates, polyester (meth)acrylates, polyether (meth)acrylates, urethane (meth)acrylates, (meth)acrylated poly(meth)acrylates and mixtures thereof.

Non-limiting examples of epoxy (meth)acrylates are the reaction products of an epoxide (such as glycidyl ethers, glycidyl esters, cycloaliphatic epoxides or epoxides obtained by epoxidation of mono- and/or polyunsaturated compounds) with a (meth)acrylating agent (such as (meth)acrylic acid, (meth)acrylic anhydride, (meth)acryloyl chloride or combinations thereof). The epoxide may be an epoxide EPOX selected from 1,2,3,4-diepoxybutane; 1,2,4,5-diepoxypentane; 1,2,5,6-diepoxyhexane; 1,2,7,8-diepoxyoctane; 1,2,9,10-diepoxydecane; bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexanecarboxylate, 2-(3,4-epoxycyclohexyl-5,5-spiro-3,4-epoxy) cyclohexane-1,4-dioxane, bis(3,4-epoxycyclohexylmethyl) adipate, vinylcyclohexene oxide, 4-vinylepoxycyclohexane, bis(3,4-epoxy-6-methylcyclohexylmethyl) adipate,3,4-epoxy-6-methylcyclohexyl-3′,4′-epoxy-6′-methylcyclohexanecarboxylate, methylenebis(3,4-epoxycyclohexane), dicyclopentadiene diepoxide, di(3,4-epoxycyclohexylmethyl) ether of ethylene glycol, ethylenebis(3, 4-epoxycyclohexanecarboxylate), ethylene glycol diglycidyl ether, 1,2- or 1,3-propylene glycol diglycidyl ether, 1,2-, 1,3- or 1,4-butanediol diglycidyl ether, 1,5-pentanediol diglycidyl ether, 1,6-hexanediol diglycidyl ether, 1,7-hexanediol diglycidyl ether, 1,8-octanediol diglycidyl ether, 1,9-nonanediol diglycidyl ether, 1,10-decanediol diglycidyl ether, 1,12-dodecanediol diglycidyl ether, 2-methyl-1,3-propanediol diglycidyl ether, neopentyl glycol diglycidyl ether, 2,2-diethyl-1,3-propane diol diglycidyl ether, 3-methyl-1,5-pentanediol diglycidyl ether, 3,3-dimethyl-1,5-pentanediol diglycidyl ether, 2,4-diethyl-1,5-pentanediol diglycidyl ether, 3,3-butylethyl-1,5-pentane diol diglycidyl ether, di-, tri- or tetra(ethylene glycol) diglycidyl ether, di-, tri- or tetra(1,2-propylene glycol) diglycidyl ether, di-, tri- or tetra(1,3-propylene glycol) diglycidyl ether, di-, tri- or tetra(1,4-butylene glycol) diglycidyl ether, a poly(ethylene glycol) diglycidyl ether, a poly(propylene glycol) diglycidyl ether, a poly(trimethylene glycol) diglycidyl ether, a poly(tetramethylene glycol) diglycidyl ether, a poly(ethylene glycol-co-propylene glycol) diglycidyl ether, glycerol triglycidyl ether, a polyglycerol polyglycidyl ether, trimethylolmethane triglycidyl ether, trimethylolethane triglycidyl ether, trimethylolpropane triglycidyl ether, di(trimethylolpropane) tetraglycidyl ether, pentaerythritol tetraglycidyl ether, diglycidyl cyclohexanedicarboxylate, cyclohexane diglycidyl ether, cyclohexane-1,4-dimethanol diglycidyl ether, tricyclodecane dimethanol diglycidyl ether, isosorbide diglycidyl ether, pyrocatechol diglycidyl ether, resorcinol diglycidyl ether, cardol diglycidyl ether, phloroglucinol triglycidyl ether, pyrogallol triglycidyl ether, tris(hydroxyphenyl) methane triglycidyl ether, tris(hydroxyphenyl) ethane triglycidyl ether, diglycidyl phthalate, diglycidyl terephthalate, diglycidyl isophthalate, polyglycidyl ethers of a polyether polyol obtained by the addition of one or more alkylene oxides to an aliphatic polyhydric alcohol such as ethylene glycol, propylene glycol, and glycerol, diglycidyl esters of aliphatic long-chain (C6-C22) dibasic acids, monoglycidyl ethers of aliphatic higher alcohols, monoglycidyl ethers of phenol, cresol, butyl phenol, or polyether alcohols obtained by the addition of alkylene oxide to these compounds, glycidyl esters of higher fatty acids, an epoxidized vegetable oil (such as epoxidized soybean oil and epoxidized linseed oil), epoxybutylstearic acid, epoxyoctylstearic acid, epoxidized polybutadiene, triglycidyl isocyanurate and the like.

Non-limiting examples of polyester (meth)acrylates are the reaction products of a hydroxyl group-terminated polyester polyol with a (meth)acrylating agent (such as (meth)acrylic acid, (meth)acrylic anhydride, (meth)acryloyl chloride or combinations thereof). The reaction process may be conducted such that a significant concentration of residual hydroxyl groups remain in the polyester (meth)acrylate or may be conducted such that all or essentially all of the hydroxyl groups of the polyester polyol have been (meth)acrylated. The polyester polyols can be made by polycondensation reactions of a polyhydroxyl functional component (in particular a diol) and a polycarboxylic acid functional compound (in particular, a dicarboxylic acid or anhydride). To prepare the polyester (meth)acrylates, the hydroxyl groups of the polyester polyol are then partially or fully esterified by reacting with the (meth)acrylating agent. Polyester (meth)acrylates may also be synthesized by reacting a hydroxyl-containing (meth)acrylate such as a hydroxyalkyl (meth)acrylate (e.g., hydroxyethyl acrylate) with a polycarboxylic acid. The polyhydroxyl functional and polycarboxylic acid functional components can each have linear, branched, cycloaliphatic or aromatic structures and can be used individually or as mixtures.

Non-limiting examples of polyether (meth)acrylates are the condensation reaction products of a polyetherol which is a polyether polyol with a (meth)acrylating agent (such as (meth)acrylic acid, (meth)acrylic anhydride, (meth)acryloyl chloride or combinations thereof). Suitable polyetherols can be linear or branched substances containing ether bonds and terminal hydroxyl groups. Polyetherols can be prepared by ring opening polymerization of epoxides and other oxygen-containing heterocyclic compounds (e.g., ethylene oxide, 1,2-propylene oxide, butene oxide, tetrahydrofuran and combinations thereof) with a starter molecule. Suitable starter molecules include water, hydroxyl functional materials, polyester polyols and amines. Polyetherols may also be obtained by the condensation of diols such as glycols.

Non-limiting examples of urethane (meth)acrylates are the condensation reaction products of at least one polyisocyanate (e.g., diisocyanate, triisocyanate), at least one polyol (such as a polyether polyol or a polyester polyol) and a hydroxyl-functionalized (meth)acrylate (such as 2-hydroxyethyl (meth)acrylate or 3-hydroxypropyl (meth)acrylate) to provide terminal (meth)acrylate groups. For example, the urethane (meth)acrylate may contain two, three, four or more (meth)acrylate groups per molecule. The order of addition of the components to prepare the urethane (meth)acrylate is well known in the art. For example, the hydroxyl-functionalized (meth)acrylate may be first reacted with the polyisocyanate to obtain an isocyanate-functionalized (meth)acrylate, which is then reacted with the polyol. In yet another embodiment, the polyisocyanate may be first reacted with the polyol to obtain an isocyanate-functionalized polyol, which is thereafter reacted with a hydroxyl-functionalized (meth)acrylate. Alternatively, all the components may be combined and reacted at the same time.

Non-limiting examples of (meth)acrylated poly(meth)acrylates are substances having an oligomeric (meth)acrylic backbone which is functionalized with one or (meth)acrylate groups (which may be at a terminus of the oligomer or pendant to the acrylic backbone). The (meth)acrylic backbone may be a homopolymer, random copolymer or block copolymer comprised of repeating units of (meth)acrylic monomers. The (meth)acrylic monomers may be any monomeric (meth)acrylate such as C₁-C₆ alkyl (meth)acrylates as well as functionalized (meth)acrylates such as (meth)acrylates bearing hydroxyl, carboxylic acid and/or epoxy groups. (Meth)acrylated poly(meth)acrylates may be prepared using any procedures known in the art, such as by oligomerizing (meth)acrylic monomers, at least a portion of which are functionalized with hydroxyl, carboxylic acid and/or epoxy groups (e.g., hydroxyalkyl (meth)acrylates, (meth)acrylic acid, glycidyl (meth)acrylate) to obtain a functionalized poly(meth)acrylate, which is then reacted with one or more (meth)acrylate-containing reactants to introduce the desired (meth)acrylate functional groups.

The curable composition may comprise from 0 to 80 wt. %, in particular from 5 to 75 wt. %, more particularly from 10 to 70 wt. %, even more particularly from 15 to 60 wt. %, more particularly still from 20 to 50 wt. % of (meth)acrylate-functionalized oligomer, based on the total weight of the curable composition. In particular, the curable composition may comprise from 0 to 50 wt. %, from 1 to 45 wt. %, from 5 to 40 wt. %, from 10 to 35 wt. % or 15 to 30 wt. % of (meth)acrylate-functionalized oligomer, based on the total weight of the polymerizable component.

The curable composition may comprise an amine synergist. Some examples of amine synergists include tertiary amines. When an amine-synergist containing monomer is included in the acrylic copolymer in conjunction with the Norrish Type II chromophore of the polymerized chromophore monomer unit, the tertiary amine provides an active hydrogen donor site for the excited triplet state of the chromophore, thus producing a reactive alkyl-amino radical that subsequently can initiate polymerization. Tertiary amines are also able to convert unreactive peroxy species, formed by reaction between oxygen and free radicals, to reactive alkyl-amino radicals, thus reducing the effects of oxygen on curing. Examples of amine synergists that may be a component of the polymerized additional monomer include low-molecular weight tertiary amines (i.e. tertiary amines having a molecular weight of less than 200 g/mol) such as triethanol amine, N-methyldiethanol amine. Other types of amine synergists are aminobenzoates, polymerizable aminobenzoates, polymeric aminobenzoates and mixtures thereof. Examples of aminobenzoates include ethyl 4-(dimethylamino)benzoate (EDB), pentyl 4-(dimethylamino)benzoate, 2-ethylhexyl 4-(dimethylamino)benzoate and 2-butoxyethyl 4-(dimethylamino)benzoate (BEDB).

The curable composition may comprise from 0.1 to 10%, in particular from 1 to 5% of amine synergist based on the weight of the curable composition. Alternatively, the curable composition may be substantially free of an amine synergist (i.e. when the acrylic copolymer comprises polymerized additional monomer units exhibit synergist functionality as described above, such as polymerized additional monomer units comprising a tertiary amine functional group). In particular, the curable composition may comprise less than 0.1%, in particular less than 0.05%, more particularly less than 0.001%, even more particularly 0% by weight of amine synergist other than the acrylic copolymer of the present invention.

In embodiments, the curable compositions may be liquid at a temperature of 25° C.±2° C. In embodiments, the curable composition may have a viscosity, as measured by Brookfield DV-III viscometer using Spindle SC-27 at 60° C., of equal to or less than 50,000 cP, such as equal to or less than 45,000 cP, equal to or less than 40,000 cP, equal to or equal than 35,000 cP, equal to or less than 30,000 cP, equal to or less than 25,000 cP, equal to or less than 20,000 cP, 15,000 cP or less, 12,500 cP or less, or even 10,000 cP or less. Such viscosity features facilitate spreading of the composition on a substrate for film formation.

In a preferred embodiment, the curable composition may have a viscosity, as measured by Brookfield DV-III viscometer using Spindle SC-27 at 25° C., of equal to or less than 50,000 cP, such as equal to or less than 45,000 cP, equal to or less than 40,000 cP, equal to or equal than 35,000 cP, equal to or less than 30,000 cP, equal to or less than 25,000 cP, equal to or less than 20,000 cP, 15,000 cP or less, 12,500 cP or less, or even 10,000 cP or less.

In embodiments, the curable compositions may comprise less than 1 wt % of solvent and less than 1 wt % of water or are free of solvent and are free of water. In embodiments, a film or coating may be formed by curing the curable composition.

### Method of Preparing and Curing the Curable Composition

The invention also relates to a method of preparing the curable composition according to the invention. The method of preparing the curable composition comprises the following steps:
preparing an acrylic copolymer according to the invention dissolved in a non-reactive solvent;
adding the reactive diluent to obtain a diluted curable composition;
removing at least part of the non-reactive solvent from the diluted curable composition to obtain the curable composition according to the invention.

The acrylic copolymer dissolved in a non-reactive solvent may be prepared by solution polymerization as described above. The acrylic copolymer, the non-reactive solvent and the reactive diluent may be as defined above. The non-reactive solvent may be at least partly removed by heating the diluted curable composition, for example at a temperature of 40° C. or more, in particular 50° C. or more, more particularly 60° C. or more. The amount of non-reactive solvent after the removal step may be less than 1%, less than 0.5%, or even 0%, by weight of non-reactive solvent based on the weight of the curable composition.

The invention also relates to a method of curing the curable composition according to the invention. The method of curing the curable composition comprises curing the curable composition.

The curing step may be carried out at ambient temperature (i.e. 10-30° C.).

The curing step may be carried out by irradiating the composition with a light source having a wavelength and/or an intensity that is able to activate the polymerized chromophore monomer units of the acrylic copolymer of the invention and cause crosslinking of said acrylic copolymer and/or said reactive diluent. The curing step may be carried out in the absence of a photoinitiator other than the acrylic copolymer of the invention. In other words, the curable composition may comprise less than 0.1%, in particular less than 0.05%, more particularly less than 0.001%, even more particularly 0% by weight of photoinitiator other than the acrylic copolymer of the present invention, based on the weight of the curable composition.

The method of curing the curable composition of the invention may not involve a pre-curing step, in particular a step of curing at least part of the reactive diluent prior to crosslinking the acrylic copolymer of the invention, for example by irradiating the curable composition with a light source having a long wavelength and/or a low intensity in the presence of a photoinitiator other than the acrylic copolymer of the present invention. As used herein, a light source having a long wavelength and/or a low intensity is a light source that is not able to activate the polymerized chromophore monomer units of the acrylic copolymer of the invention and cause crosslinking of said acrylic copolymer. An example of a light source having a long wavelength and/or a low intensity is a blacklight (as opposed to a LED-UV lamp which is able to activate chromophores comprising a thioxanthone moiety). Preferably, the method of curing the curable composition of the invention comprises a curing step in which at least part of the reactive diluent and at least part of the acrylic copolymer of the invention are simultaneously cured. Without being bound by theory, such a curing method is believed to enable the grafting of at least part of the reactive diluent on at least part of the oligomer of the invention.

### Cured Composition

The acrylic copolymers described herein may be cured in combination with a reactive diluent, preferably at least one (meth)acrylate monomer, or at least one (meth)acrylate oligomer, or both, to obtain a cured composition. In embodiments, a cured composition that is a product of photocuring a composition comprising an acrylic copolymer according to embodiments described herein and a reactive diluent, preferably at least one (meth)acrylate monomer, exhibits: an APHA-10 mm initial color from 0.1 to 50; an initial yellowness (b*) from 0.01 to 2; and a T_{g} of equal to or greater than 0° C.

In some embodiments, the cured composition exhibits an APHA-10 mm initial color from 0.1 to 50, from 0.1 to 45, from 0.1 to 40, from 0.5 to 45, from 1.0 to 45, from 2.0 to 40, from 3.0 to 40, from 4.0 to 40, from 5.0 to 40, from 7.0 to 40, or from 10.0 to 40. In other embodiments, the cured composition exhibits an APHA-10 mm initial color from 0.1 to 10, from 0.3 to 9, from 0.5 to 9, from 1 to 9, from 2 to 9, from 2.5 to 9, from 2.5 to 8, from 2.5 to 7.5, or from 3 to 7.

In some embodiments, the cured composition exhibits an initial yellowness (b*) from 0.01 to 2, from 0.05 to 2, from 0.1 to 2, from 0.1 to 1.7, from 0.1 to 1.5, from 0.2 to 1.5, from 0.3 to 1.5, from 0.4 to 1.5, from 0.4 to 1.4, from 0.4 to 1.3, or from 0.5 to 1.2. In other embodiments, the cured composition exhibits an initial yellowness (b*) from 0.01 to 1.0, from 0.05 to 1.0, from 0.1 to 1.0, from 0.1 to 0.7, from 0.1 to 0.6, from 0.15 to 0.55, or from 0.2 to 0.5.

In embodiments, the cured composition may have a T_{g} of equal to or greater than 0° C., such as equal to or greater than 5° C., equal to or greater than 10° C., equal to or greater than 15° C., equal to or greater than 20° C., equal to or greater than 25° C., equal to or greater than 30° C., equal to or greater than 35° C., equal to or greater than 40° C., equal to or greater than 45° C., or equal to or greater than 50° C. In embodiments, the cured composition may have a T_{g} of from 0° C. to 100° C.

In some embodiments, the cured composition does not comprise a tertiary amine synergist.

In embodiments, the cured composition does not comprise a small molecule photoinitiator (i.e. a non-polymeric photoinitiator).

In embodiments, the composition is photocured by illumination of the composition with a Phoseon LED 395 nm bulb. In other embodiments, the composition is photocured by illumination of the composition with an LC6 Fusion, H-bulb.

In some embodiments, the at least one (meth)acrylate oligomer is included and is chosen from at least one of urethane acrylate and urethane methacrylate, and the at least one (meth)acrylate monomer is included and is chosen from at least one of 2-hydroxyethyl methacrylate and isobornyl methacrylate.

The acrylic copolymers described herein may be incorporated into methods for coating a substrate. In embodiments, a method of coating a substrate includes applying a composition to a substrate to form an uncured coating of the composition on the substrate, the composition comprising: an acrylic copolymer according to embodiments described herein; and a reactive diluent (preferably at least one (meth)acrylate monomer); and exposing the uncured coating to UV radiation to cure the composition and obtain a cured coating on the substrate. Example substrates that may be coated include, without limitation, glass, polycarbonate, PET, polyethylene, polypropylene, metals, human and synthetic fingernails, paper and products including cardboard and paperboard, and ceramics.

Acrylic copolymers according to embodiments described herein may be used in graphic arts, inks, and industrial coatings applications for which a yellowing of the acrylic copolymer, a cured composition prepared from the acrylic copolymer, or a coating including the acrylic copolymer and applied to a substrate, may be unfavorable.

### EXAMPLES

The following examples are illustrative in nature, and should not be understood to limit the subject matter of the present disclosure. Using embodiments described above, an exemplary reactive acrylic copolymer was prepared and used according to the following examples.

### Materials

2-Carboxymethylthioxanthone (CMTX), 4-acryloyloxy benzophenone, methyl ethyl ketone (MEK), butyl acrylate (BA), t-butyl acrylate, glycidyl methacrylate (GMA), methyl methacrylate (MMA), acetic acid, and hydroxyethyl ethylene urea methacrylate were all were purchased from Sigma Aldrich Chemical Company. Urethane methacrylate (UMA, CN1968®), urethane acrylate (UA, CN963®), hydroxyethyl methacrylate (HEMA, SR170®) and isobornyl methacrylate (IBOMA, SR423A®), ditrimethylolpropane tetraacrylate (DMPTA, SR355®), 2-isothioxanthone (ITX, Speedcure ITX®), and 2-ethylhexyl 4-(dimethylamino)benzoate (EHDMA, Speedcure EHA®) are common UV-curable monomers and photoinitiators that were developed at Sartomer.

### Preparation of Curable Compositions

All curable compositions were prepared by adding the components to a Flacktek® polypropylene cup and mixing until homogenous at 1500-2000 rpm for 2 minutes using a Flacktek® DAC 400.2 VAC high speed mixer.

### Testing Procedures

To determine gel content, the following procedure was employed. Sample was pipetted onto a clean glass slide and a 3 MIL coating was created using a ByK draw-down square. The drawdown thickness used depended on the final methyl ethyl ketone (MEK) percentage in the reactive acrylic copolymer. For instance, Reactive Acrylic Copolymer 1 (RAC 1) was drawn down with a four MIL thickness to result in a three MIL coating of RAC 1 after evaporation of the MEK. After the draw-down, the glass slides were placed in a 60° C. oven for 1 hour to remove the solvent. To cure, the glass slides underwent 3 passes under a LC6 Fusion H bulb curing unit at 15 feet per minute. For the gel contents that were conducted in nitrogen, the glass slides were placed in a nitrogen chamber and flooded with nitrogen for 10 minutes, then the chamber was passed under the H bulb for curing. After curing, the cross-linked reactive acrylic copolymer film was removed from the glass slide. Its initial weight was recorded, and then the removed sample was submerged in MEK for 24 hours. To determine the final weight of the cross-linked reactive acrylic copolymer, the sample was vacuum filtered from the MEK and placed in a 60° C. oven to evaporate excess MEK.

For the photo differential scanning calorimetry experiments, the following procedure was employed. To prepare the sample, an initial weight ratio of RAC 1 to ditrimethylolpropane tetraacrylate (DMPTA, SR355®) monomer was added to a Flacktek mixing cup and mixed at 2000 RPM for 2 minutes using a Flacktek® DAC 400.2 VAC high-speed mixer. A small amount of sample (5-10 mg) was placed into an aluminum Tzero pan, which was then placed in the oven at 60° C. for 1-2 hours to drive off any residual solvent. The initial ratio of RAC 1:ditrimethylolpropane tetraacrylate was selected to achieve a 1:1 weight ratio of RAC 1:ditrimethylolpropane tetraacrylate after the solvent was flashed off. The sample was placed in a TA instruments Q2000 DSC equipped with an EFOS A4000 Acticure UV/Visible light curing system containing a 100 W Mercury lamp light source, along with a reference pan. The UV-light intensity was measured out of the sample window using an EIT UV power puck II radiometer prior to the experiment. During the experiment, the temperature is stabilized at 25° C. After one minute of equilibrium, UV light (broad spectrum) is turned on and the heat flow generated from the sample was recorded for two minutes. The lamp was turned off and the experiment was allowed to run for an additional minute to bring heat flow down to baseline. The total duration of the experiment was four minutes.

For the UV Curable Coatings Composition, the following procedure was employed. To prepare UV/LED curable coatings composition, a sample was pipetted onto a clean glass slide (4 inch×4 inch). A ByK 3 Mil draw down bar was used to draw down the sample onto the glass. The coating was placed in a 60° C. oven for 1 hour to remove the MEK. All coatings were ~3 MIL wet thickness once MEK was evaporated. After drying, the coating was passed under either (1) a LC6 Fusion H bulb curing unit three times at 15 feet per minute or (2) a Phoseon LED 395 nm bulb, 3 passes, 30 fpm to crosslink the coatings composition. Once cured, initial color, haze and yellowness were measured on a Hunter Lab ColorQuest XE spectrometer. Specifically, color, haze, and yellowness are typically measured on a liquid resin using a Hunter Lab Colorimeter and is measured via ASTM D1209 APHA/Pt—Co color scale in accordance with the instrumental ASTM D5386 method. This method was modified to measure color, haze, and yellowness on a coating through glass using a modified method. Hunter Lab ColorQuest XE spectrometer. Other performance properties such as surface tack, Konig hardness, and adhesion were also measured. Konig hardness of the coatings formulations were measured using ASTM D4366. Surface tack was determined qualitatively by assigning a number from the arbitrary scale from 0 to 5 (0 for no tack/5 for very tacky). Adhesion testing was measured using the ASTM 3359 Method B.

### Example 1

### Preparation of PA 1

Preparation of Photoinitiator Adduct 1 (PA 1) was achieved substantially as depicted in Scheme I:

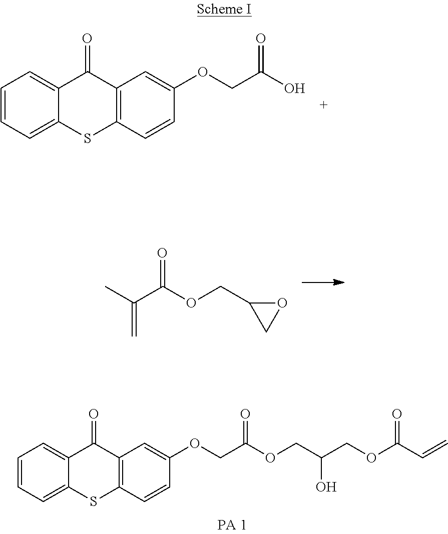

Briefly, a round bottom flask equipped with stirrer, thermocouple, heating mantle, side arm and condenser was loaded with glycidyl methacrylate (GMA), inhibitor, and solvent. The apparatus was heated to 110° C. 2-carboxymethoxythioxanthone (CMTX) was added slowly while the reaction was heating. After the addition of CMTX was complete, the mixture was sparged with air and then heated at 110° C. for 30 min to fully dissolve the CMTX. The reaction mixture was cooled to less than 50° C., catalyst was added, and then heated to 85° C. The reaction mixture was held at 85° C. until the reaction was complete as determined by acid value and residual GMA via GC external standard.

### Example 2

### Preparation of RAC 1

PA 1 was further reacted with butyl acrylate (BA) and methyl methacrylate (MMA) in methyl ethyl ketone (MEK) to form Reactive Acrylic Copolymer 1 (RAC 1). Table 1 lists the ratios of the components in RAC 1 as well as the solvent percentage remaining in the final product, the predicted T_{g}, and the molecular weight.

The acrylic copolymer was obtained by solution polymerization of the monomers indicated in Table 1 using an amount of MEK as solvent as indicated in Table 1. The solvent and monomers were added to a 60 mL vial. A Vazo 52 initiator solution in the solvent was prepared in a separate vial, then added to the monomer solution (total monomer:initiator weight ratio of 400:1). The vial was then put into a water bath at 65° C. and lightly shaken for 11 hours. The type of solvent, solids content, reaction temperature, reaction time and initiator:monomer ratio can be adjusted to produce acrylic copolymers of various molecular weights using experimental conditions well known by those skilled in the art.

Monomer:Vazo 52 ratios between 100:1 and 1000:1 were typically used to produce acrylic copolymers of relatively low molecular weights as described and used in the following examples.

TABLE 1
Composition of RAC 1

| | | Final | Predicted | Molecular |
|---|---|---|---|---|
| Copolymer | Backbone (wt. %) | MEK (%) | T_{g} (° C.) | Weight (M_{w}) |
| RAC 1 | 95 BA - 4 MMA - | 31.2 | −46 | 28523 |
| | 1.7 CMTX-GMA | | | |

### Example 3

### Curing Properties of RAC 1

Further experiments revealed that RAC 1 exhibits low self-reactivity. Specifically, upon evaporation of MEK and curing RAC 1 in air and nitrogen using a Fusion H Bulb at 15 feet per minute, 3 passes, RAC 1 remained a liquid, which indicated that three passes was insufficient to photocrosslink the system and form a gel. A second attempt was made at curing RAC 1 by passing it under the Fusion H bulb a total of 10 times at 15 feet per minute in order to obtain a gel like consistency. The gel content of RAC 1 was found to be less 10% (see Tables 2 and 3, entry 1). In an attempt to increase the curing speed and facilitate crosslinking, 2-ethylhexyl 4-(dimethylamino)benzoate (EHDMA, Speedcure EHA®) was added at 3% to RAC 1. Gel content remained below 10% for RAC 1+3% EHDMA and the formulation still took 10 passes under the lamp to fully cure (see Tables 2 and 3, entry 2). Finally, the multifunctional monomer ditrimethylolpropane tetraacrylate (DMPTA, SR355®) was added to the formulation. With DMPTA, the formulation cured in three passes under the Fusion and had a high gel content, both with and without the addition of EHDMA (see Tables 2 and 3, entries 3 and 4).

TABLE 2
Gel Content % of Compositions including
RAC 1 After Curing in Air

| | | | Gel | Gel Content |
|---|---|---|---|---|
| | Gel | Gel | Content | Standard |
| Composition | Content 1 | Content 2 | Average | Deviation |
| RAC 1 | 7.1 | 6.6 | 6.835 | 0.37 |
| RAC 1 + 3% EHDMA | 8.59 | 10.8 | 9.695 | 1.56 |
| 1:1 DMPTA:RAC 1 | 75.8 | 72.3 | 74.05 | 2.47 |
| 1:1 DMPTA:RAC 1 + | 68.4 | 66.8 | 67.6 | 1.13 |
| 3% EHDMA | | | | |

TABLE 3
Gel Content % of Compositions including
RAC 1 After Curing in Nitrogen

| | | | Gel | Gel Content |
|---|---|---|---|---|
| | Gel | Gel | Content | Standard |
| Composition | Content 1 | Content 2 | Average | Deviation |
| RAC 1 | 8.73 | 9.68 | 9.205 | 0.67 |
| RAC 1 + 3% EHDMA | 8.38 | 10.8 | 9.59 | 1.71 |
| 1:1 DMPTA:RAC 1 | 64.7 | 61.4 | 63.05 | 2.33 |
| 1:1 DMPTA:RAC 1 + | 67.1 | 74.9 | 71 | 5.52 |
| 3% EHDMA | | | | |

The cure speed and enthalpy of reaction of RAC 1+3% EHDMA, 1:1 DMPTA:RAC 1, and 1:1 DMPTA:RAC 1+3% EHDMA were measured (see Table 4). RAC 1+3% EHDMA cured the slowest. This result is consistent with RAC 1 having a low gel content. 1:1 DMPTA:RAC 1 had a very fast cure time (0.16 min) due to the inclusion of the monomer. Adding 3% EHDMA to the 1:1 DMPTA:RAC 1 formulation further increased cure speed (0.04 min). The RAC 1 systems with DMPTA exhibited similar heat generation during cure while the RAC 1+3% EHDMA exhibited lower heat generation.

TABLE 4
Cure Speed and Enthalpy of Reaction in
Compositions Including RAC 1 in Air

| | Time to Peak Max | Area Under Curve |
|---|---|---|
| Composition | (min) | (J/g) |
| RAC 1 + 3% SC | 0.68 | 106.7 |
| 1:1 SR355:RAC 1 | 0.16 | 242.4 |
| 1:1 SR355:RAC 1 + 3% SC | 0.04 | 205.3 |

The above results reveal that RAC 1 may act as a polymeric photoinitiator in the presence of other acrylate functionalized monomers, but it exhibits little self-reactivity.

### Example 4

### Cured Compositions Including RAC 1 and (Meth)Acrylate Monomers

RAC 1 was tested in different curable compositions. Each composition included either urethane methacrylate (UMA, CN1968®) or urethane acrylate (UA, CN963®) along with both hydroxyethyl methacrylate (HEMA, SR170®) and isobornyl methacrylate (IBOMA, SR423A®) at two different weight percentages (11.2% RAC 1 or 28% RAC 1). The two different weight percentages afforded an active amount of chromophore of 0.14% or 0.37%, based on RAC 1 having 1.7% chromophore loaded on the backbone and taking into account the 30% MEK in the RAC 1 that would eventually be removed upon drying. The compositions are shown in Table 5, and are denoted Inventive 1 (11), Inventive 2 (12), Inventive 3 (13), and Inventive 4 (14). For comparison, a small molecule photoinitiator based on 2-isothioxanthone (ITX, Speedcure ITX®) with a similar amount of MEK was used with the same monomer mixtures. The comparative compositions are shown in Table 5 and denoted as Comparative 1 (C1), Comparative 2 (C2), Comparative 3 (C3) and Comparative 4 (C4).

TABLE 5
Curable Compositions Including RAC 1 or ITX as the Photoinitiator

| | C1 | C2 | I1 | I2 | C3 | C4 | I3 | I4 |
|---|---|---|---|---|---|---|---|---|
| UMA | 16.25 | | 16.25 | | 12.5 | | 12.5 | |
| UA | | 16.25 | | 16.25 | | 12.5 | | 12.5 |
| HEMA | 2.5 | 2.5 | 2.5 | 2.5 | 2.5 | 2.5 | 2.5 | 2.5 |
| IBOMA | 2.5 | 2.5 | 2.5 | 2.5 | 2.5 | 2.5 | 2.5 | 2.5 |
| MEK | 2.75 | 2.75 | | | 6.875 | 6.875 | | |
| ITX | 0.05 | 0.05 | | | 0.125 | 0.125 | | |
| RAC 1 | | | 2.8 | 2.8 | | | 7.0 | 7.0 |
| Total | 25 | 25 | 25 | 25 | 25 | 25 | 25 | 25 |

For each of the curable compositions, two samples were taken. One sample was cured under a Fusion H-bulb and the other sample was cured under a Phoseon LED 395 nm. The performance properties of the cured compositions are shown in Table 6 (Fusion H-bulb cured) and Table 7 (Phoseon LED 395 nm cured).

Referring to the LC6 Fusion H-bulb cured compositions (Table 6), the initial color of the films after photocuring for comparative compositions C1, C2, C3, and C4 was shown to be greater than 100 (APHA, 10 mm) compared to less than 50 for each of the inventive compositions 11, 12, 13, and 14. The initial yellowness (b*) values of the films after photocuring was greater than 4 for all comparative compositions, while less than 1.2 for all inventive compositions.

Referring to the Phoseon LED 395 nm cured compositions (Table 7), the initial color of the films after photocuring for comparative compositions C1, C2, C3, and C4 was shown to be greater than 55 (APHA, 10 mm) compared to less than 7 for each of the inventive compositions 11, 12, 13, and 14. The initial yellowness (b*) values of the films after photocuring was greater than 4 for all comparative compositions, while less than 0.5 for all inventive compositions.

With both the LC6 Fusion H-bulb cured and the Phoseon LED 395 nm cured compositions, haze values were higher for the low concentration inventive compositions after curing, which may be due to the interaction of the acrylic backbone with the urethane (meth)acrylate oligomers, which may indicate a small degree of incompatibility. The haze values were notably lower for the compositions containing higher concentrations of RAC 1, which may be due to better compatibility with the matrix as concentration is increased. Adhesion improved at higher concentrations of RAC 1 due to the low T_{g} nature of the backbone. For the LC6 Fusion H-bulb cured compositions, surface tack was low and surface hardness was high for the UA formulations, indicating a fully cross-linked system.

TABLE 6
Properties of Cured Compositions Including RAC 1 or ITX as the
Photoinitiator (LC6 Fusion H-bulb Cured)

| | C1 | C2 | I1 | I2 | C3 | C4 | I3 | I4 |
|---|---|---|---|---|---|---|---|---|
| Formulation | Clear | Clear | Cloudy | Cloudy | Clear | Clear | Slightly | Slightly |
| | | | | | | | Cloudy | Cloudy |
| Initial Color | 108.5 | 152.2 | 31.53 | 36.13 | 149.7 | 171.8 | 22.75 | 14.56 |
| (APHA, 10 mm) | | | | | | | | |
| Initial Haze | 0.87 | 2.90 | 40.24 | 35.44 | 0.19 | 0.13 | 19.19 | 12.45 |
| Initial | 4.06 | 5.56 | 1.01 | 1.16 | 5.53 | 6.28 | 0.76 | 0.57 |
| Yellowness (b*) | | | | | | | | |
| Surface Tack | 1.5 | 0 | 4 | 1.5 | 1 | 0 | 3 | 1.5 |
| Hardness | 16 | 96 | 15 | 61 | 16 | 121 | 15 | 63 |
| (Konig, ASTM | | | | | | | | |
| D4366) | | | | | | | | |
| Adhesion (Cross | 1 | 0 | 0 | 1 | 0.5 | 0 | 2.5 | 5 |
| Hatch, ASTM | | | | | | | | |
| D3359) | | | | | | | | |

TABLE 7
Properties of Cured Compositions Including RAC 1 or ITX as the
Photoinitiator (Phoseon LED 395 nm Cured)

| | C1 | C2 | I1 | I2 | C3 | C4 | I3 | I4 |
|---|---|---|---|---|---|---|---|---|
| Formulation | Clear | Clear | Slightly | Slightly | Clear | Clear | Clear | Clear |
| | | | Cloudy | Cloudy | | | | |
| Initial Color | 109.6 | 57.64 | 6.01 | 6.76 | 115.5 | 66.28 | 3.35 | 6.57 |
| (APHA, 10 | | | | | | | | |
| mm) | | | | | | | | |
| Initial Haze | 0.62 | 2.08 | 22.21 | 27.14 | 0.24 | 0.71 | 7.03 | 19.22 |
| Initial | 8.06 | 4.31 | 0.33 | 0.43 | 8.45 | 4.90 | 0.23 | 0.46 |
| Yellowness | | | | | | | | |
| (b*) | | | | | | | | |
| Surface Tack | 2 | 1 | 4 | 3 | 2 | 1 | 5 | 4 |
| Hardness | 13 | 36 | 4 | 2 | 8 | 35 | 5 | 2 |
| (Konig, ASTM | | | | | | | | |
| D4366) | | | | | | | | |
| Adhesion | 0 | 1 | 4 | 5 | 0 | 5 | 5 | 5 |
| (Cross Hatch, | | | | | | | | |
| ASTM D3359) | | | | | | | | |

To further elucidate why the cured compositions comprising RAC 1 exhibited significantly lower yellowing than the cured compositions comprising ITX, further comparative compositions were prepared. In particular, curable compositions comprising CMTX and PA 1 as small molecule photoinitiators were prepared with the same mixture of monomers as the above compositions. The two different weight percentages gave an active amount of chromophore of 0.2% or 0.5%. MEK was left in the system to evaporate off, similar to the inventive compositions discussed above. The comparative compositions are shown in Table 8 and denoted as Comparative 5 (C5), Comparative 6 (C6), Comparative 7 (C7), Comparative 8 (C8), Comparative 9 (C9), Comparative 10 (C10), Comparative 11 (C11), and Comparative 12 (C12).

TABLE 8
Curable compositions Including CMTX or PA 1 as the Photoinitiator.

| | C5 | C6 | C7 | C8 | C9 | C10 | C11 | C12 |
|---|---|---|---|---|---|---|---|---|
| UMA | 16.25 | | 16.25 | | 12.5 | | 12.5 | |
| UA | | 16.25 | | 16.25 | | 12.5 | | 12.5 |
| HEMA | 2.5 | 2.5 | 2.5 | 2.5 | 2.5 | 2.5 | 2.5 | 2.5 |
| IBOMA | 2.5 | 2.5 | 2.5 | 2.5 | 2.5 | 2.5 | 2.5 | 2.5 |
| MEK | 2.75 | 2.75 | 2.75 | 2.75 | 6.875 | 6.875 | 6.875 | 6.875 |
| CMTX | 0.05 | 0.05 | | | 0.125 | 0.125 | | |
| PA 1 | | | 0.05 | 0.05 | | | 0.125 | 0.125 |
| Total | 25 | 25 | 25 | 25 | 25 | 25 | 25 | 25 |

The compositions were cured via Fusion H-bulb and the performance properties of the resulting cured compositions are shown in Table 9. The initial color of the films after photocuring all C5-C12 was again shown to be much greater than 100 (APHA, 10 mm) compared to less than 50 for each of the inventive compositions. The initial yellowness (b*) values of the films after photocuring was greater than 6 for all comparative compositions, compared with less than 1.2 for the inventive compositions. Similar to the earlier compositions, surface tack was low and surface hardness was high for the UA formulations, indicating a fully cross-linked system.

TABLE 9
Properties of Cured Compositions Including CMTX or PA 1 as the
Photoinitiator (LC6 Fusion H-bulb)

| | C5 | C6 | C7 | C8 | C9 | C10 | C11 | C12 |
|---|---|---|---|---|---|---|---|---|
| Formulation | Clear | Clear | Clear | Clear | Clear | Clear | Clear | Clear |
| Initial Color | 184.0 | 252.2 | 171.6 | 252.7 | 293.8 | 514.7 | 307.6 | 612.3 |
| (APHA, 10 mm) | | | | | | | | |
| Initial Haze | 0.24 | 0.32 | 0.30 | 0.40 | 0.56 | 0.84 | 0.52 | 0.98 |
| Initial | 6.66 | 8.82 | 6.29 | 8.88 | 10.68 | 17.35 | 11.18 | 20.52 |
| Yellowness (b*) | | | | | | | | |
| Surface Tack | 1 | 0 | 1 | 0 | 1 | 0 | 1 | 0 |
| Hardness | 11 | 67 | 10 | 64 | 5 | 72 | 4 | 68 |
| (Konig, ASTM | | | | | | | | |
| D4366) | | | | | | | | |
| Adhesion (Cross | 3 | 2 | 4 | 1 | 5 | 5 | 5 | 1 |
| Hatch, ASTM | | | | | | | | |
| D3359) | | | | | | | | |

Further comparative curable compositions were prepared that included both small molecule PA 1 along with a non-reactive acrylic copolymer with the same backbone components as RAC 1, but without a PA 1 moiety connected to the backbone. By testing this control, it can be understood whether the acrylic copolymer backbone is playing a role in the low initial yellowing. The comparative compositions, which were prepared with the same mixture of monomers as the above compositions, are shown in Table 10 and denoted as Comparative 13 (C13), Comparative 14 (C14), Comparative 15 (C15), and Comparative 16 (C16).

TABLE 10
Curable compositions Including PA 1
and Non-reactive Acrylic Copolymer.

| | C13 | C14 | C15 | C16 |
|---|---|---|---|---|
| UMA | 16.25 | | 12.5 | |
| UA | | 16.25 | | 12.5 |
| HEMA | 2.5 | 2.5 | 2.5 | 2.5 |
| IBOMA | 2.5 | 2.5 | 2.5 | 2.5 |
| PA 1 | 0.05 | 0.05 | 0.125 | 0.125 |
| Non-reactive acrylic copolymer in MEK | 2.8 | 2.8 | 7.0 | 7.0 |
| Total | 25 | 25 | 25 | 25 |

The curable compositions were cured via Fusion H-bulb and the performance properties of the resulting cured compositions are shown in Table 11. The performance properties of the coatings compositions containing PA 1 along with the non-reactive acrylic copolymer are shown in Table 11. The initial color of the films after photocuring all C13-C16 was again shown to be much greater than 100 (APHA, 10 mm) compared to less than 50 for each of the inventive compositions. The initial yellowness (b*) values of the films after photocuring was again greater than 6 for all comparative compositions, compared with less than 1.2 for the inventive compositions.

TABLE 11
Properties of Cured Compositions Including PA 1 and
non-reactive acrylic copolymer (LC6 Fusion H-bulb)

| | C13 | C14 | C15 | C16 |
|---|---|---|---|---|
| Formulation | Clear | Clear | Clear | Clear |
| Initial Color (APHA, 10 mm) | 255.2 | 379.7 | 206.7 | 335.3 |
| Initial Haze | 37.05 | 30.34 | 49.61 | 61.57 |
| Initial Yellowness (b*) | 8.87 | 12.96 | 7.31 | 11.44 |
| Surface Tack | 1 | 0 | 1 | 0 |
| Hardness (Konig, ASTM D4366) | 13 | 96 | 9 | 103 |
| Adhesion (Cross Hatch, ASTM | 1 | 5 | 1 | 5 |
| D3359) | | | | |

The UMA compositions seem to have lower initial yellowing compared to the UA compositions. This may be due to the differences in the polyol backbone for each of the urethane (meth)acrylate oligomers. The UMA backbone has a polyol that has the ability to undergo hydrogen abstraction easier than the polyol in the UA backbone. Still, initial yellowing is elevated in C13 and C15 compared with the inventive compositions indicating that the use of RAC 1 as the photoinitiator provides lower yellowing than the combination of PA 1 and non-reactive acrylic copolymer. Without being bound by theory, it is believed that having the PA 1 moiety bound to the backbone of RAC 1 reduces the probability of the PA 1 moiety dimerizing, which is a source of yellowing.

### Aspects

Further aspects of the invention are provided by the subject matter of the following clauses:

Clause 1. An acrylic copolymer comprising the reaction product of: a high-T_{g} monomer having a glass transition temperature (T_{g}) equal to or greater than 25° C., a low-T_{g} monomer having a T_{g} less than 25° C., or a combination of a high-T_{g} monomer having a glass transition temperature (T_{g}) equal to or greater than 25° C. and a low-T_{g} monomer having a T_{g} less than 25° C.; a chromophore monomer comprising a moiety chosen from a thioxanthone, an anthraquinone, or a camphorquinone; and an optional additional monomer.

Clause 2. The acrylic copolymer of clause 1, wherein the oligomer has formula (I)

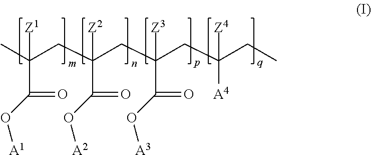

wherein:
each A¹ is independently (C₁-C₃₀) hydrocarbyl or (C₁-C₃₀) heterohydrocarbyl, preferably (C₁-C₃₀) hydrocarbyl;
each A² is independently (C₄-C₃₀) hydrocarbyl or (C₄-C₃₀) heterohydrocarbyl, preferably (C₄-C₃₀) hydrocarbyl;
each A³ is independently a residue comprising a monovalent radical comprising a moiety chosen from a thioxanthone, an anthraquinone, or a camphorquinone, preferably a thioxanthone;
each A⁴ is independently a (C₁-C₃₀) hydrocarbyl or (C₁-C₃₀) heterohydrocarbyl;
Z¹, Z², Z³, and Z⁴ are independently-H or (C₁-C₄)alkyl, preferably-H or —CH₃;
m is a weight fraction of the high-T_{g} monomer and is from 0 to 0.999;
n is a weight fraction of the low-T_{g} monomer and is from 0 to 0.999;
p is a weight fraction of the chromophore monomer and is from 0.001 to 0.4;
q is a weight fraction of the additional monomer and is from 0 to 0.2;
m+n is greater than or equal to 0.4; and
m+n+p+q=1.

Clause 3. The acrylic copolymer of clause 2, wherein: m is from 0.001 to 0.999, preferably 0.01 to 0.50; and n is from 0.001 to 0.999, preferably from 0.50 to 0.98; and m+n is greater than or equal to 0.6.

Clause 4. The acrylic copolymer of clauses 2 or 3, wherein Z¹ is methyl, A¹ is methyl, and A² is n-butyl.

Clause 5. The acrylic copolymer of any of clauses 2 to 4, wherein A³ is a monovalent radical comprising a thioxanthone moiety.

Clause 6. The acrylic copolymer of any of clauses 2 to 5, wherein A³ has formula (IVa) or (IVb):

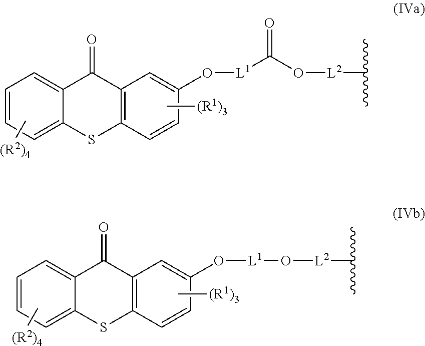

wherein:
L¹ is an alkylene;
L² is a divalent linker comprising at least 2 carbon atoms;
each R¹ and R² are independently selected from —H, halogen, alkyl, cycloalkyl, heterocycloalkyl, alkoxy, aryloxy, thioalkyl, thioaryl, alkenyl, alkynyl, aryl, aralkyl, alkaryl, heteroaryl, —C(═O)R^{a}, —NR^{b}R^{c}, alkylamino, alkylthiol, haloalkyl, —NO₂, CN, —C(═O)OR₄, —C(═O) NR^{b}R^{c};
R^{a} is selected from an optionally substituted alkyl, an optionally substituted cycloalkyl, an optionally substituted heterocycloalkyl and an optionally substituted aryl;
R^{b}, R^{c} and R^{d} are independently selected from —H, alkyl and aryl.

Clause 7. The acrylic copolymer of any of clauses 2 to 6, wherein q is 0.

Clause 8. The acrylic copolymer of any of the preceding clauses, wherein A¹ is methyl, A² is n-butyl, and A³ has formula (IVc) or (IVd):

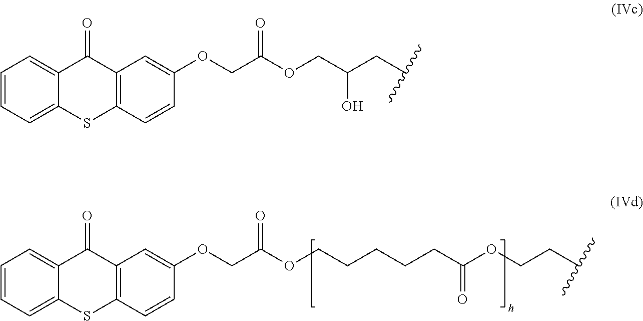

wherein h is 1 to 20.

Clause 9. The acrylic copolymer of any of the preceding clauses, wherein Z¹ is methyl, 72 is —H, and Z³ is —H.

Clause 10. The acrylic copolymer of any of the preceding clauses, wherein q is not equal to zero and the at least one additional monomer comprises at least one amine synergist monomer.

Clause 11. The acrylic copolymer of any of the preceding clauses, comprising high-T_{g} monomers and low-T_{g} monomers, wherein the Fox Equation average T_{g} of the high-T_{g} monomers is at least 20° C. greater than the Fox Equation average T_{g} of the low-T_{g} monomers.

Clause 12. The acrylic copolymer of any of the preceding clauses, comprising high-T_{g} monomers and low-T_{g} monomers, wherein the difference between the Fox Equation average T_{g} of the high-T_{g} monomer units and the Fox Equation average T_{g} of the low-T_{g} monomer units is from 20° C. to 200° C.

Clause 13. The acrylic copolymer of any of the preceding clauses, comprising at least two discrete types of high T_{g} monomers.

Clause 14. The acrylic copolymer of any of the preceding clauses, comprising at least two discrete types of low T_{g} monomers.

Clause 15. The acrylic copolymer of any of the preceding clauses, wherein comprising high-T_{g} monomers and low-T_{g} monomers, wherein the weight ratio of low T_{g} monomers to high T_{g} monomer units in the acrylic copolymer is from 10:1 to 1:9.

Clause 16. The acrylic copolymer of any of the preceding clauses, comprising at least one high-T_{g} monomer chosen from 2-phenylethyl methacrylate, 3,3,5-trimethylcyclohexyl acrylate, tert-butyl acrylate, octadecyl methacrylate, octadecyl acrylate, propyl methacrylate, benzyl methacrylate, isobutyl methacrylate, ethyl methacrylate, 2,2,3,3-tetrafluoropropyl methacrylate, 2,2,2-trifluoroethyl methacrylate, isopropyl methacrylate, isobornyl acrylate, methyl methacrylate, isobornyl methacrylate, phenyl methacrylate, tert-butyl methacrylate, cyclohexyl methacrylate, 4-tert-butylcyclohexyl acrylate, 4-tert-butylcyclohexyl methacrylate, 3,3,5-trimethylcyclohexyl acrylate, 3,3,5-trimethylcyclohexyl methacrylate, a substituted or unsubstituted (C₆-C₁₂) cycloalkyl (meth)acrylate, adamantyl (meth)acrylate, tricyclodecane methanol mono(meth)acrylate, or combinations thereof.

Clause 17. The acrylic copolymer of any of the preceding clauses, comprising at least one low T_{g} monomer chosen from n-butyl (meth)acrylate, isobutyl acrylate, hexyl (meth)acrylate, 2-ethylhexyl (meth)acrylate, isooctyl (meth)acrylate, isodecyl (meth)acrylate, tridecyl (meth)acrylate, lauryl (meth)acrylate, nonyl acrylate, decyl (meth)acrylate, octyl (meth)acrylate, propyl acrylate, isobutyl acrylate, 2,2,3,3-tetrafluoropropyl acrylate, ethyl acrylate, sec-butyl acrylate, dodecyl acrylate, tetradecyl (meth)acrylate, isopropyl acrylate, pentyl (meth)acrylate, benzyl acrylate, cyclohexyl acrylate, hexadecyl (meth)acrylate, 2-methylbutyl acrylate, 2-octyl acrylate, or combinations thereof.

Clause 18. The acrylic copolymer of any of the preceding clauses, comprising at least one chromophore monomer according to formula (IVe) or (IVf)

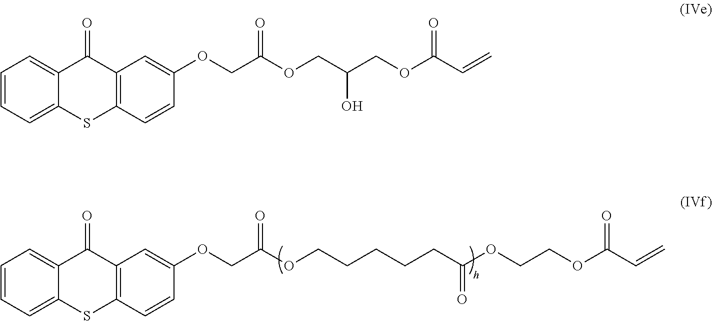

wherein h is 1 to 10.

Clause 19. The acrylic copolymer of any of the preceding clauses, comprising at least one additional monomer chosen from a caprolactone-extended acrylate (SR49B, Sartomer), cyclic trimethylolpropane formal acrylate (SR531, Sartomer) propoxylated tetrahydrofurfuryl acrylate (SR611, Sartomer), beta-carboxyethylacrylate, glycidyl methacrylate, or 2-(2-ethoxyethoxy)ethyl acrylate (SR256), neopentyl monomethacrylate, tetrahydrofurfuryl (meth)acrylate, phenoxyethyl acrylate, 2-hydroxypropyl (meth)acrylate, 2-hydroxyethyl (meth)acrylate, 2-cyanobutyl acrylate, 4-cyanobutyl acrylate, 2-cyanoethyl acrylate, cyanomethyl acrylate, and combinations thereof.

Clause 20. The acrylic copolymer of any of the preceding clauses, comprising at least one additional monomer chosen from (meth)acrylic acid, dimethylaminoethylacrylate (DMAEA), dimethylaminoethylmethacrylate (DMAEMA), diethylaminoethyl acrylate (DEAEA), diethylaminoethyl methacrylate (DEAEMA), N-vinylpyrrolidone (NVP), N-vinylcaprolactam (VCAP), acryloxymorpholine (ACMO), dimethyl acrylamide (DMAC), a poly(ethylenoxide) mono(meth)acrylate, hydroxyethyl ethylene urea (meth)acrylate (HEEU (M) A), the reaction product of a cyclic anhydride with a hydroxy-functional (meth)acrylate, and combinations thereof.

Clause 21. The acrylic copolymer of any of the preceding clauses, comprising at least one additional monomer chosen from aminobenzoates, polymerizable aminobenzoates, polymeric aminobenzoates and mixtures thereof.

Clause 22. The acrylic copolymer of any of the preceding clauses, wherein the acrylic copolymer has a glass transition temperature T_{g} equal to or less than −10° C.

Clause 23. A curable composition comprising the acrylic copolymer according to any preceding clause and one or more of the following compounds: (meth)acrylate monomers, diluents, (meth)acrylate oligomers, amine synergists, fillers, photoinitiators, slip agents, thickeners, slip agents, hindered amine light stabilizers, ultraviolet absorbing monomers, or other auxiliary additives.

Clause 24. The curable composition of clause 23, wherein the curable composition comprises a reactive diluent.

Clause 25. The curable composition of clause 24, wherein the reactive diluent comprises a monofunctional (meth)acrylate monomer having a T_{g} that is higher than 25° C., in particular a monofunctional (meth)acrylate monomer selected from 2-phenylethyl methacrylate, neopentyl methacrylate, 3,3,5-trimethylcyclohexyl acrylate, tert-butyl acrylate, octadecyl methacrylate, octadecyl acrylate, glycidyl methacrylate, propyl methacrylate, tetrahydrofurfuryl methacrylate, benzyl methacrylate, isobutyl methacrylate, glycidyl methacrylate, ethyl methacrylate, 2,2,3,3-tetrafluoropropyl methacrylate, 2-hydroxypropyl methacrylate, 2,2,2-trifluoroethyl methacrylate, 2-hydroxyethyl methacrylate, isopropyl methacrylate, isobornyl acrylate, methyl methacrylate, butyl cyanoacrylate, isobornyl methacrylate, phenyl methacrylate, 2-cyanobutyl acrylate, tert-butyl methacrylate, cyclohexyl acrylate, cyclohexyl methacrylate, 4-tert-butylcyclohexyl acrylate, 4-tert-butylcyclohexyl methacrylate, ethyl cyanoacrylate, methyl cyanoacrylate, 3,3,5-trimethylcyclohexyl acrylate, 3,3,5-trimethylcyclohexyl methacrylate, a substituted or unsubstituted (C₆-C₁₂) cycloalkyl (meth)acrylate, adamantyl (meth)acrylate, dicyclopentanyl (meth)acrylate, tricyclodecane methanol mono(meth)acrylate, 2-phenoxyethyl methacrylate, or combinations thereof.

Clause 26. The curable composition of clause 24 or 25, wherein the reactive diluent comprises a polyfunctional (meth)acrylate, in particular a polyfunctional (meth)acrylate selected from bisphenol A di(meth)acrylate; hydrogenated bisphenol A di(meth)acrylate; ethylene glycol di(meth)acrylate; diethylene glycol di(meth)acrylate; triethylene glycol di(meth)acrylate; tetraethylene glycol di(meth)acrylate; polyethylene glycol di(meth)acrylate; propylene glycol di(meth)acrylate; dipropylene glycol di(meth)acrylate; tripropylene glycol di(meth)acrylate; tetrapropylene glycol di(meth)acrylate; polypropylene glycol di(meth)acrylate; polytetramethylene glycol di(meth)acrylate; 1,2-butanediol di(meth)acrylate; 2,3-butanediol di(meth)acrylate; 1,3-butanediol di(meth)acrylate; 1,4-butanediol di(meth)acrylate; 1,5-pentanediol di(meth)acrylate; 1,6-hexanediol di(meth)acrylate; 1,8-octanediol di(meth)acrylate; 1,9-nonanediol di(meth)acrylate; 1,10-nonanediol di(meth)acrylate; 1,12-dodecanediol di(meth)acrylate; neopentyl glycol di(meth)acrylate; 2-methyl-2,4-pentanediol di(meth)acrylate; polybutadiene di(meth)acrylate; cyclohexane-1,4-dimethanol di(meth)acrylate; tricyclodecane dimethanol di(meth)acrylate; metallic di(meth)acrylates; modified metallic di(meth)acrylates; glyceryl di(meth)acrylate; glyceryl tri(meth)acrylate; trimethylolethane tri (meth)acrylate; trimethylolethane di(meth)acrylate; trimethylolpropane tri (meth)acrylate; trimethylolpropane di(meth)acrylate; pentaerythritol di(meth)acrylate; pentaerythritol tri(meth)acrylate; pentaerythritol tetra(meth)acrylate, di(trimethylolpropane) diacrylate; di(trimethylolpropane) triacrylate; di(trimethylolpropane) tetraacrylate, sorbitol penta (meth)acrylate; di(pentaerythritol) tetraacrylate; di(pentaerythritol) pentaacrylate; di(pentaerythritol) hexa(meth)acrylate; tris(2-hydroxyethyl) isocyanurate tri(meth)acrylate; as well as the alkoxylated (e.g., ethoxylated and/or propoxylated) derivatives thereof; and combinations thereof.

Clause 27. The curable composition of any one of clauses 24 to 26, wherein the curable composition is substantially free of a photoinitiator other than the acrylic copolymer according to any one of clauses 1 to 22, in particular, the curable composition comprises less than 0.1%, in particular less than 0.05%, more particularly less than 0.001%, even more particularly 0% by weight of photoinitiator other than the acrylic copolymer according to any one of clauses 1 to 22.

Clause 28. The curable composition of any one of clauses 24 to 27, wherein the curable composition comprises an amine synergist.

Clause 28. The curable composition of any one of clauses 24 to 27, wherein the curable composition is substantially free of an amine synergist.

Clause 29. A cured composition that is a product of photocuring a composition comprising: an acrylic copolymer according to any of clauses 1 to 22; and a reactive diluent, preferably at least one (meth)acrylate monomer, or at least one (meth)acrylate oligomer, or both; wherein the cured composition exhibits: an APHA-10 mm initial color from 0.1 to 50; an initial yellowness (b*) from 0.01 to 2; and a T_{g} of equal to or greater than 0° C.

Clause 30. The cured composition of clause 29, wherein the cured composition exhibits an APHA-10 mm initial color from 0.1 to 40.

Clause 31. The cured composition of clause 29 or 30, wherein the cured composition exhibits an initial yellowness (b*) from 0.01 to 1.2.

Clause 32. The cured composition of any of clauses 29 to 31, wherein the composition does not comprise a tertiary amine synergist.

Clause 33. The cured composition of any of clauses 29 to 32, wherein the composition does not comprise a small molecule photoinitiator.

Clause 34. The cured composition of any of clauses 29 to 33, wherein the at least one (meth)acrylate oligomer is included and is chosen from at least one of urethane acrylate and urethane methacrylate, and the at least one (meth)acrylate monomer is included and is chosen from at least one of 2-hydroxyethyl methacrylate and isobornyl methacrylate.

Clause 35. The cured composition of any of clauses 29 to 34, wherein the acrylic copolymer has a weight average molecular weight of at least 10,000 g/mol.

Clause 36. A method of coating a substrate, the method comprising: applying a composition to a substrate to form an uncured coating of the composition on the substrate, the composition comprising: the acrylic copolymer according to any of clauses 1 to 22; and a reactive diluent, preferably at least one (meth)acrylate monomer; and exposing the uncured coating to UV radiation to cure the composition and obtain a cured coating on the substrate.

Clause 37. The method of clause 36, wherein the substrate is chosen from glass, polycarbonate, PET, polyethylene, polypropylene, metals, human and synthetic fingernails, paper and products including cardboard and paperboard, and ceramics.

It will be apparent to persons of ordinary skill in the art that various modifications and variations can be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter.

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment.

Amendments to and listing of the claims:

1. An acrylic copolymer comprising the reaction product of:
a high-T_{g} monomer having a glass transition temperature (T_{g}) equal to or greater than 25° C., a low-T_{g} monomer having a T_{g} less than 25° C., or a combination of a high-T_{g} monomer having a glass transition temperature (T_{g}) equal to or greater than 25° C. and a low-T_{g} monomer having a T_{g} less than 25° C.;
a chromophore monomer comprising a moiety chosen from a thioxanthone, an anthraquinone, or a camphorquinone; and
an optional at least one additional monomer.

2. The acrylic copolymer of claim 1, wherein the acrylic copolymer has formula (I): 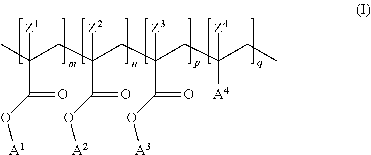
wherein:
each A¹ is independently (C₁-C₃₀) hydrocarbyl or (C₁-C₃₀) heterohydrocarbyl;
each A² is independently (C₄-C₃₀) hydrocarbyl or (C₄-C₃₀) heterohydrocarbyl;
each A³ is independently a residue comprising a monovalent radical comprising a moiety chosen from a thioxanthone, an anthraquinone, or a camphorquinone;
each A⁴ is independently a (C₁-C₃₀) hydrocarbyl or (C₁-C₃₀) heterohydrocarbyl;
Z¹, Z², Z³, and Z⁴ are independently-H or (C₁-C₄)alkyl;
m is a weight fraction of the high-T_{g} monomer and is from 0 to 0.999;
n is a weight fraction of the low-T_{g} monomer and is from 0 to 0.999;
p is a weight fraction of the chromophore monomer and is from 0.001 to 0.4;
q is a weight fraction of the additional monomer and is from 0 to 0.2;
m+n is greater than or equal to 0.4; and
m+n+p+q=1.

3. The acrylic copolymer of claim 2, wherein:
m is from 0.001 to 0.999; and
n is from 0.001 to 0.999;
m+n is greater than or equal to 0.6.

4. The acrylic copolymer of claim 2, wherein Z¹ is methyl, A¹ is methyl, and A² is n-butyl.

5. The acrylic copolymer of claim 2, wherein A³ is a monovalent radical comprising a thioxanthone.

6. The acrylic copolymer of claim 2, wherein A³ has formula (IVa) or (IVb): 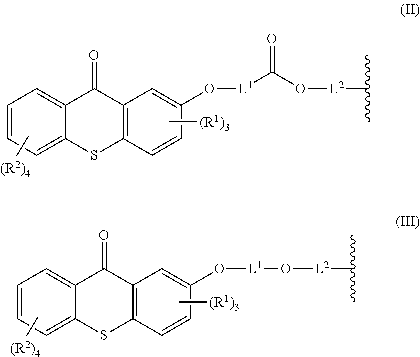
where, in formula (IVa) and formula (IVb):
L¹ is an alkylene;
L² is a divalent linker comprising at least 2 carbon atoms;
each R¹ and R² are independently selected from —H, halogen, alkyl, cycloalkyl, heterocycloalkyl, alkoxy, aryloxy, thioalkyl, thioaryl, alkenyl, alkynyl, aryl, aralkyl, alkaryl, heteroaryl, —C(═O)R^{a}, —NR^{b}R^{c}, alkylamino, alkylthiol, haloalkyl, —NO₂, —CN, —C(═O)OR^{d}, —C(═O) NR^{b}R^{c};
R^{a} is selected from an optionally substituted alkyl, an optionally substituted cycloalkyl, an optionally substituted heterocycloalkyl and an optionally substituted aryl; and
R^{b}, R^{c} and R^{d} are independently selected from —H, alkyl and aryl.

7. The acrylic copolymer of claim 2, wherein q is 0.

8. A curable composition comprising the acrylic copolymer according to claim 1 and a reactive diluent.

9. The curable composition of claim 8, wherein the reactive diluent comprises a monofunctional (meth)acrylate monomer having a Tg that is higher than 25° C.

10. The curable composition of claim 8, wherein the reactive diluent comprises a polyfunctional (meth)acrylate.

11. The curable composition of claim 8, wherein the curable composition is substantially free of a photoinitiator other than the acrylic copolymer.

12. A method of preparing a curable composition comprising the following steps:
preparing an acrylic copolymer as defined in claim 1 dissolved in a non-reactive solvent;
adding the reactive diluent to obtain a diluted curable composition; and
removing at least part of the non-reactive solvent from the diluted curable composition to obtain the curable composition.

13. A method of curing the curable composition of claim 8, wherein the method comprises curing the curable composition by irradiating the curable composition with a light source having a wavelength and/or an intensity that is able to activate the polymerized chromophore monomer units of the acrylic copolymer and cause crosslinking of said acrylic copolymer and/or said reactive diluent.

14. A cured composition that is a product of photocuring a composition comprising:
an acrylic copolymer according to claim 1; and
a reactive diluent;
wherein the cured composition exhibits:
an APHA-10 mm initial color from 0.1 to 50;
an initial yellowness (b*) from 0.01 to 2; and
a T_{g} of equal to or greater than 0° C.

15. The cured composition of claim 14, wherein the cured composition exhibits an APHA-10 mm initial color from 0.1 to 40.

16. The cured composition of claim 14, wherein the cured composition exhibits an initial yellowness (b*) from 0.01 to 1.2.

17. The cured composition of claim 14, wherein the composition does not comprise a tertiary amine synergist.

18. The cured composition of claim 14, wherein the composition does not comprise a small molecule photoinitiator.

19. The cured composition of claim 14, wherein the at least one (meth)acrylate oligomer is included and is chosen from at least one of urethane acrylate and urethane methacrylate, and the at least one (meth)acrylate monomer is included and is chosen from at least one of 2-hydroxyethyl methacrylate and isobornyl methacrylate.

20. The cured composition of claim 14, wherein the acrylic copolymer has a weight average molecular weight of at least 10,000 g/mol.

21. A method of coating a substrate, the method comprising:
applying a composition to a substrate to form an uncured coating of the composition on the substrate, the composition comprising:
the acrylic copolymer according to claim 1; and
a reactive diluent; and
exposing the uncured coating to UV radiation to cure the composition and obtain a cured coating on the substrate.
